(19) United States
(12) Patent Application Publication
(10) Pub. No.: US 2025/0225335 A1
(43) Pub. Date: Jul. 10, 2025

(54) Computer Program and Method for Annotated Document Processing Based on User-Defined Parameters

(71) Applicant: Deep Water Point & Associates, McLean, VA (US)

(72) Inventors: Jie Ma, Ashburn, VA (US); David Murray Bridgeland, Sterling, VA (US); Brian Christopher Seagrave, Vienna, VA (US)

(21) Appl. No.: 18/406,782

(22) Filed: Jan. 8, 2024

(51) Int. Cl. G06F 40/40; G06F 16/35

(52) U.S. Cl. CPC G06F 40/40; G06F 16/35

(57) ABSTRACT

Embodiments are directed towards a computer-implemented method for identifying one or more matching elements from a taxonomy present in a document. The method may include identifying the document, the taxonomy, and a question that may be processed by a large language model (LLM). The method may further include applying at least one taxonomy augmented generation (TAG) tactic from a set of TAG tactics to the identified document and to the identified taxonomy. The method may also include generating an input prompt that may be configured to be used as an input for the LLM, where the input prompt may include a document context derived from the document, a taxonomy context derived from the taxonomy, and the question to be processed by the LLM. The method may further include providing the input prompt to the LLM, and receiving a response generated by the LLM.

### BACKGROUND

Every generative artificial intelligence (AI) application that uses a large language model (LLM) needs to determine how the rest of the application interacts with the LLM. Normally, determining that interaction involves three main steps: (i) constructing a prompt, (ii) prompting the LLM, and (iii) processing a response. (i) Constructing the prompt normally involves creating templates, dynamically choosing which templates to employ, and efficiently managing inputs for the LLM. (ii) Prompting the LLM involves accessing the LLM through standardized interfaces. (iii) Processing the response involves extracting valuable information from the LLM outputs. Many LLM applications require user-specific data that is not part of the model's original training set. Often this user-specific data is provided in one or more large documents. One way of preparing user-specific data is using Retrieval Augmented Generation (RAG). Another way of preparing user-specific data is to divide the large documents into chunks, adding chunks with other context information to the prompts, executing the prompts one by one, and finally merging and processing the results into one overarching result.

### SUMMARY

In one or more embodiments of the present disclosure, a computer-implemented method for identifying one or more matching elements from a taxonomy present in a document is provided. The method may include identifying the document, the taxonomy, and a question that may be processed by a large language model (LLM). The method may further include applying at least one taxonomy augmented generation (TAG) tactic from a set of TAG tactics to the identified document and the identified taxonomy. The method may also include generating an input prompt that may be configured to be received as an input for the LLM, where the input prompt may include a document context derived from the document, a taxonomy context derived from the taxonomy, and the question to be processed by the LLM. The method may further include providing the input prompt to the LLM, and receiving a response generated by the LLM.

One or more of the following features may be included. The set of TAG tactics may include: attribute trimming, hierarchical diving, hierarchy flattening, singular item focusing, and borrowing alignment. Each tactic of the set of TAG tactics may be configured to reduce the size of an input prompt for the LLM. The total combined size of the input prompt may be less than the size of a maximum token constraint for the LLM. Applying the attribute trimming TAG tactic may remove one or more user-designated attributes from the taxonomy context before the input prompt is generated. Applying the hierarchical diving TAG tactic may further include: identifying a top-layer taxonomy, up to (N−2) intermediate layer taxonomies, and a bottom-layer taxonomy, such that a total of N-layers may be identified. Applying the hierarchical diving TAG may also include constructing a top-layer taxonomy context, generating a top-layer input prompt, providing the top-layer input prompt to the LLM, and receiving a top-layer response generated by the LLM. Applying the hierarchical diving TAG may further include, iteratively constructing intermediate-layer taxonomy contexts, iteratively generating intermediate-layer input prompts, and iteratively receiving intermediate-layer responses for each of the (N−2) intermediate-layer taxonomies until either only the bottom layer taxonomy remains, or until the number of taxonomy items left may be addressed by a single input prompt. Applying the hierarchical diving TAG may also include, in response to receiving intermediate-layer responses until only the bottom-layer taxonomy remains constructing a bottom-layer taxonomy context, generating a bottom-layer input prompt, providing the bottom-layer input prompt to the LLM, receiving a bottom-layer response generated by the LLM, and merging all N responses from each layer into a final result. Applying the hierarchical diving TAG may further include, in response to receiving intermediate-layer responses for each of the (N−2) intermediate-layer taxonomies until the number of taxonomy items remaining may be addressed by a single input prompt, addressing the remaining taxonomy items with the single input prompt. Applying the hierarchy flattening TAG tactic may assign an ID tag that retains hierarchy information for each taxonomy item included in the taxonomy context. The singular item focusing TAG tactic may include: identifying N distinct taxonomy elements within the taxonomy context, generating a corresponding input prompt for each of the N-identified taxonomy elements, providing each of the N-generated input prompts into the LLM one at a time, receiving N-distinct responses generated by the LLM one at a time, and merging all N-distinct responses into a final result. Applying the borrowing alignment TAG tactic may include: instructing the LLM to act as an expert for a specific domain of knowledge for which the LLM may have previously received training, where the specific domain of knowledge may encompass one or more scopes of the taxonomy associated with the question, determining if the question embedded in the set of instructions for the LLM requires returning any taxonomy-related items, in response to determining that taxonomy-related items are required, extracting the taxonomy-related items from the response for each item, and performing a semantic search of the taxonomy for each item. The attribute trimming TAG tactic and the hierarchical dive TAG tactic may both be applied to the document context before the input prompt is generated. The borrowing alignment TAG tactic may not be applied in conjunction with any of the other TAG tactics. The input prompt may be provided to the LLM via at least one application programming interface (API). The taxonomy, the question, and any other instructions provided to the LLM may be customizable by an end-user.

In yet another embodiment of the present disclosure, a computer program product resides on a non-transitory computer-readable medium. The computer program product may include a plurality of instructions stored thereon. When executed by a processor, the instructions may cause the processor to perform operations including: identifying the document, the taxonomy, and a question that may be processed by a large language model (LLM), applying at least one taxonomy augmented generation (TAG) tactic from a set of TAG tactics to the identified document and to the identified taxonomy. The operations may also include generating an input prompt that may be configured to be used as an input for the LLM, where the input prompt may include a document context derived from the document, a taxonomy context derived from the taxonomy, and the question to be processed by the LLM. The operations may further include providing the input prompt to the LLM, and receiving a response generated by the LLM.

One or more of the following features may be included. The set of TAG tactics may include: attribute trimming, hierarchical diving, hierarchy flattening, singular item focusing, and borrowing alignment. Each tactic of the set of TAG tactics may be configured to reduce the size of an input prompt for the LLM. The total combined size of the input prompt may be less than the size of a maximum token constraint for the LLM. The taxonomy, the question, and any other instructions provided to the LLM may be customizable by an end-user.

Additional features and advantages of embodiments of the present disclosure will be set forth in the description that follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts an LLM-taxonomy process coupled to a distributed computing network;

FIG. 2 shows a flow chart depicting conventional interactions between generative artificial intelligence (AI) applications and large language models (LLM);

FIG. 3 shows a diagrammatic representation of how an LLM uses a chunk-based approach to process user-specific data, in accordance with embodiments of the present disclosure;

FIG. 4 shows a flow chart depicting the implementation of taxonomy augmented generation (TAG) tactics, in accordance with embodiments of the present disclosure;

FIG. 5 shows a flow chart depicting the implementation of LLM-taxonomy process 10, in accordance with embodiments of the present disclosure;

FIG. 6 shows an unabbreviated taxonomy context, in accordance with embodiments of the present disclosure;

FIG. 7 shows an abbreviated taxonomy context after undergoing the attribute trim TAG tactic, in accordance with embodiments of the present disclosure;

FIG. 8 shows an unpopulated template for an LLM prompt, in accordance with embodiments of the present disclosure;

FIG. 9 shows a question for an LLM prompt, in accordance with embodiments of the present disclosure;

FIG. 10 shows a document context for an LLM prompt, in accordance with embodiments of the present disclosure;

FIG. 11 shows a populated template for an LLM prompt, in accordance with embodiments of the present disclosure;

FIG. 12 shows an LLM-generated response to an LLM prompt, in accordance with embodiments of the present disclosure;

FIG. 13 shows an unabbreviated taxonomy context, in accordance with embodiments of the present disclosure;

FIG. 14 shows an abbreviated taxonomy context after undergoing the hierarchical diving TAG tactic, in accordance with embodiments of the present disclosure;

FIG. 15 shows a flow chart depicting the implementation of the hierarchical diving TAG tactic, in accordance with embodiments of the present disclosure;

FIG. 16 shows an unpopulated template for an LLM prompt, in accordance with embodiments of the present disclosure;

FIG. 17 shows a question for an LLM prompt, in accordance with embodiments of the present disclosure;

FIG. 18 shows a document context for an LLM prompt in accordance with embodiments of the present disclosure;

FIG. 19 shows a populated template for an LLM prompt, in accordance with embodiments of the present disclosure;

FIG. 20 shows an LLM-generated response to an LLM prompt, in accordance with embodiments of the present disclosure;

FIG. 21 shows an unabbreviated taxonomy context, in accordance with embodiments of the present disclosure;

FIG. 22 shows an abbreviated taxonomy context after undergoing the hierarchy flattening TAG tactic, in accordance with embodiments of the present disclosure;

FIG. 23 shows an unpopulated template for an LLM prompt, in accordance with embodiments of the present disclosure;

FIG. 24 shows a question for an LLM prompt, in accordance with embodiments of the present disclosure;

FIG. 25 shows a document context for an LLM prompt, in accordance with embodiments of the present disclosure;

FIG. 26 shows a populated template for an LLM prompt, in accordance with embodiments of the present disclosure;

FIG. 27 shows an LLM-generated response to an LLM prompt, in accordance with embodiments of the present disclosure;

FIG. 28 shows an unabbreviated taxonomy context, in accordance with embodiments of the present disclosure;

FIG. 29 shows an abbreviated taxonomy context after undergoing the singular-item focus TAG tactic, in accordance with embodiments of the present disclosure;

FIG. 30 shows a flow chart depicting the implementation of the singular-item focusing TAG tactic, in accordance with embodiments of the present disclosure;

FIG. 31 shows an unpopulated template for an LLM prompt in accordance with embodiments of the present disclosure;

FIG. 32 shows a question for an LLM prompt, in accordance with embodiments of the present disclosure;

FIG. 33 shows a document context for an LLM prompt, in accordance with embodiments of the present disclosure;

FIG. 34 shows a populated template for an LLM prompt, in accordance with embodiments of the present disclosure;

FIG. 35 shows an LLM-generated response to an LLM prompt, in accordance with embodiments of the present disclosure;

FIG. 36 shows an unabbreviated taxonomy context, in accordance with embodiments of the present disclosure;

FIG. 37 shows a document context for an LLM prompt, in accordance with embodiments of the present disclosure;

FIG. 38 shows a question for an LLM prompt for a chat endpoint, in accordance with embodiments of the present disclosure;

FIG. 39 shows an unpopulated template for a chat endpoint for an LLM prompt using the borrow and alignment TAG tactic, in accordance with embodiments of the present disclosure;

FIG. 40 shows user-defined inputs for a template for an LLM prompt using the borrow and alignment TAG tactic, in accordance with embodiments of the present disclosure;

FIG. 41 shows a flow chart depicting the implementation of the borrowing alignment TAG tactic, in accordance with embodiments of the present disclosure;

FIG. 42 shows an example of a user input for a chat endpoint for an LLM prompt using the borrow and alignment TAG tactic, in accordance with embodiments of the present disclosure;

FIG. 43 shows an example of a user input for a chat endpoint for an LLM prompt using the borrow and alignment TAG tactic, in accordance with embodiments of the present disclosure;

FIG. 44 shows an example of an LLM-generated response for a chat endpoint for an LLM prompt using the borrow and alignment TAG tactic, in accordance with embodiments of the present disclosure;

FIG. 45 shows an LLM-generated response to an LLM prompt, in accordance with embodiments of the present disclosure; and

FIG. 46 shows an LLM-generated response to an LLM prompt, in accordance with embodiments of the present disclosure.

### DETAILED DESCRIPTION

The invention described herein may manifest as a software product, to be sold as a subscription service. The invention may address the problem of analyzing a huge volume of unstructured documents to efficiently and quickly identify those documents relevant to a user's precisely defined interests. The invention may apply definitions of taxonomies of the various attributes of user interest for a field (such as federal contracting, science and research, law, policy, and higher education) to act as a reverse index of documents to be processed. Reverse in that the index may be defined first and then documents may be processed afterward to locate the index elements that are resident in these documents. “Taxonomy” as used herein may refer to a systematic classification scheme for organizing and categorizing concepts, entities, or objects based on their characteristics and relationships. A taxonomy may provide a structured framework for organizing knowledge, enabling efficient information retrieval, analysis, and decision-making.

The invention may apply custom taxonomies in a large language model (LLM) artificial intelligence (AI)-based question-and-answer (Q&A) process to discover attributes of a document, despite the LLM not being trained on such taxonomies, and to match these attributes to user preferences so that a score of a document's relevance to user-defined preferences may be computed. Further, the invention may address the challenges associated with incorporating a large taxonomy's context into an LLM prompt by using in-context learning while improving the accuracy and efficiency of the LLM Q&A process. Document processing and valuable outcomes are described further below.

Taxonomy augmented generation (TAG) introduces a set of tactics that may be used to frame a large custom taxonomy in the context of a large language model (LLM). TAG may involve associating pertinent documents or data points with a customized taxonomy, and creating prompts that then use a “few-shot” input to fine-tune the language model's responses. Here, few-shot learning (FSL) refers to a machine learning technique that may allow a model to make accurate predictions with only a small number of examples per class. FSL may allow the model to generalize well to new data even though it has limited training data. Provided that the taxonomy is small enough to fit into an LLM prompt, TAG may be easily applied to any given set of user-specific data. The TAG tactics described herein may be configured to deal with a large or huge taxonomy that may not fit into one LLM prompt. As such, these TAG tactics enable the application of a custom taxonomy to interact with an LLM, in either a few FSL shots or through in-context learning methods.

Generative artificial intelligences (AIs) may refer to a type of AI that uses large models to create new content. These models may learn from data and generate content on their own, unlike traditional AIs, which operate based purely on rules. Large language models (LLMs) may refer to any highly capable large language model system that may follow instructions, for example, OpenAI ChatGPT-4 which may be accessed through API endpoints. LLMs may require user-specific data that is not a part of the LLM's training set. Often this user-specific data may be provided in one or more large documents. One way of preparing user-specific data may be using retrieval augmented generation (RAG), where RAG is a technique for enhancing the accuracy and reliability of generative AI models with facts fetched from external sources. In other words, RAG may fill in the gap of user-specific data for LLMs.

In a sense, LLMs may be considered neural networks that are measured by how many parameters they contain. As such, the parameters of an LLM may be used to represent general patterns of how humans use words to form sentences, and this deep understanding, sometimes called parameterized knowledge, may make LLMs useful in responding to general prompts at light speed. However, parameterized knowledge may not serve users who wish to dive deeper into a current or more specific topic, which is where RAG may come into play.

Incorporating a taxonomy as context into an LLM prompt may present three primary challenges. Firstly, some taxonomies may be very large, exceeding the token limits of LLM models. While an LLM model may accept 4,000 to 32,000 tokens per API call, some taxonomies may exceed the 32,000-token limit without including any instructions or documents. Secondly, framing the taxonomy context as part of the question rather than being a part of the document may be complicated by the fact that RAG does not support crafting a series of questions based on a taxonomy. Framing the taxonomy context as part of the question may allow end users to exert more influence over what data the LLM focuses on when generating a response to a prompt. Taxonomies are inherently hierarchical, and as such they may include multiple levels forming a tree-like structure. The third challenge of incorporating taxonomy as context lies in effectively presenting this tree-like structure to the LLM and guiding the LLM in generating answers that align with the taxonomy's hierarchy. Overcoming these challenges may enhance the capabilities of LLMs in answering questions about a document, allowing LLMs to harness the power of large taxonomies to generate accurate and structured responses.

Regarding token allocations, both document data and taxonomy data may be very large and far exceed the capability of the LLM prompt size limit. For example, in analyzing government procurements, the total taxonomies defined may exceed 4000 pages. However, the token size of a document chunk, a prompt, and a taxonomy context combined may not exceed the LLM's maximum tokens constraint. Accordingly, the following inequality may be true for any request to an LLM: (doc chunk tokens+taxonomy context tokens+prompt tokens)<max tokens. In other words, the total number of tokens used by the portion of the document sampled to provide context for the LLM combined with the relevant portion of the taxonomy to be considered by the LLM and the questions/instructions included in a prompt for the LLM to answer/follow may be less than the total number of tokens that may be included in the prompt to be sent to the LLM.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

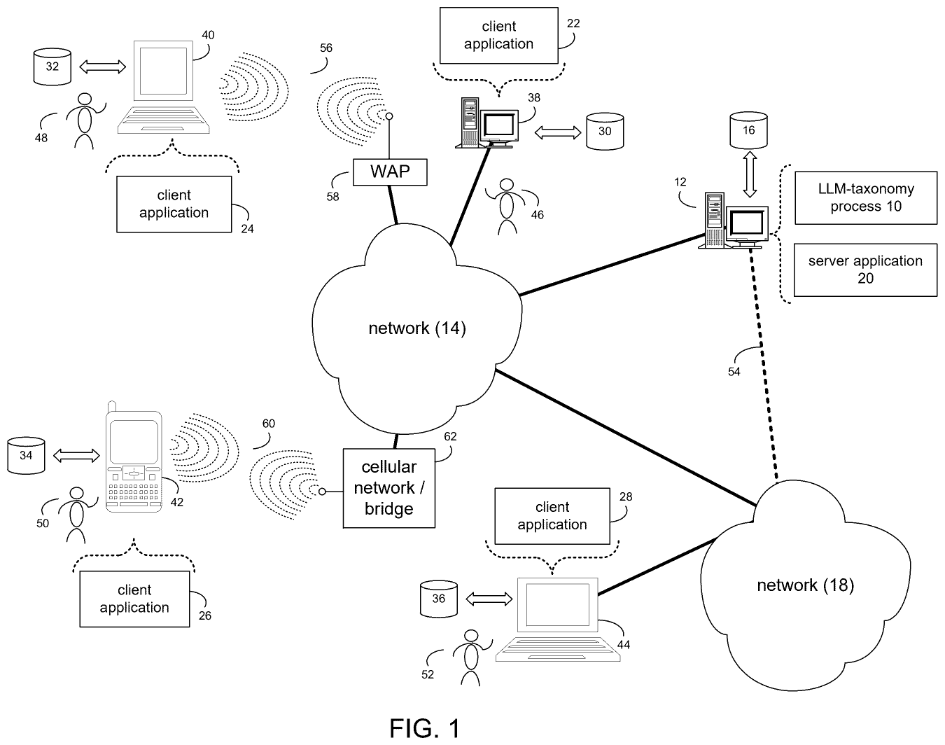

Referring to FIG. 1, there is shown an LLM-taxonomy process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally, and/or alternatively, LLM-taxonomy process 10 may reside on a client electronic device, such as a personal computer, notebook computer, personal digital assistant, or the like.

The instruction sets and subroutines of the LLM-taxonomy process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server, etc. Server application 20 may interact with one or more client applications (e.g., client applications 22, 24, 26, 28) in order to execute LLM-taxonomy process 10. Examples of client applications 22, 24, 26, 28 may include, but are not limited to, EDAs or design verification tools such as those available from the assignee of the present disclosure. These applications may also be executed by server computer 12. In some embodiments, LLM-taxonomy process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, LLM-taxonomy process 10 may be a client-side application residing on one or more client electronic devices 38, 40, 42, 44 (e.g., stored on storage devices 30, 32, 34, 36, respectively). As such, LLM-taxonomy process 10 may be a stand-alone application that interfaces with a client application (e.g., client applications 22, 24, 26, 28), or may be applets/applications that may be executed within a client application. As such, LLM-taxonomy process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, LLM-taxonomy process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

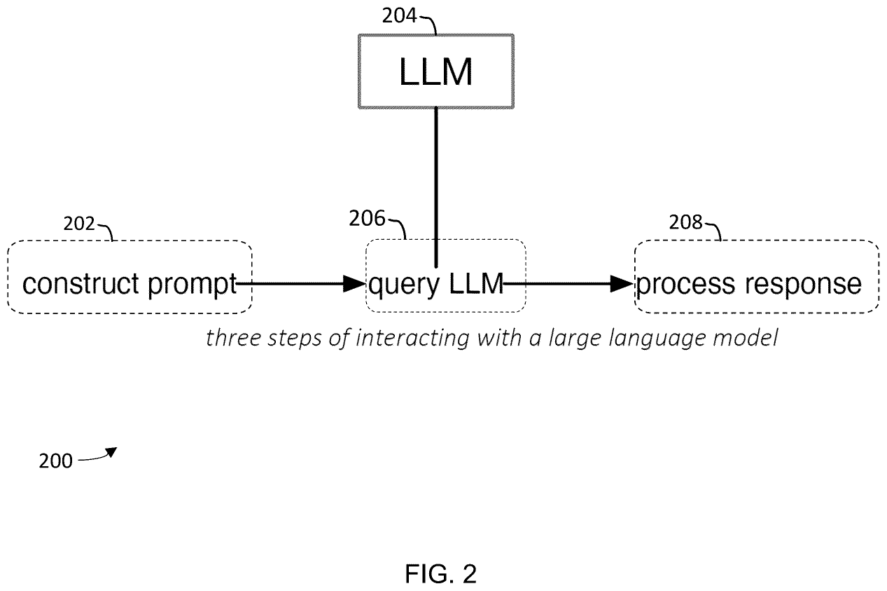

Referring now to FIG. 2, flow chart 200 depicting conventional interactions between generative artificial intelligence (AI) applications and large language models (LLM) is provided. According to flow chart 200, conventional interactions may begin by constructing 202 an input prompt by creating input templates configured to dynamically choose and efficiently manage data provided to LLM 204. The AI application may query 206 LLM 204 by accessing LLM 204 via standardized interfaces like the application protocol interface (API), and finally, the AI application may process 208 a response by extracting valuable information from the response outputs provided by LLM 204.

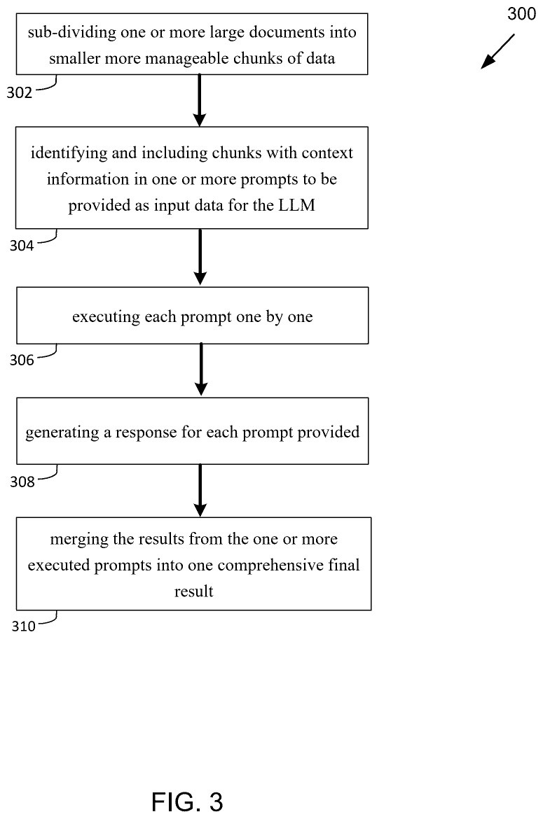

Referring now to FIG. 3, a diagrammatic representation of how an LLM may use chunk-based approach 300 to process user-specific data from one or more large documents is provided. Chunk-based approach 300 may begin by subdividing 302 the one or more large documents into smaller more manageable chunks of data. Once sub-divided, chunks including context information may be identified 304 and included in one or more prompts to be provided as input data for the LLM. Each prompt may be executed 306 one by one, and the LLM may generate 308 a response for each prompt provided. The results from the one or more executed prompts may then be merged 310 into one result that may be used to represent a single comprehensive response. The systems and methods disclosed herein are indifferent to the large document prompt method used, as they may be used with either RAG or chunk-based methods.

In some embodiments, a document chunk also called a document context may refer to a piece of the document processed by a retrieval augmented generation (RAG) method or a document batch chunking method (as described in FIG. 3), a taxonomy context may refer to a piece of the taxonomy that is small enough to be added to LLM prompts, and a prompt may refer to a text message to be sent to the LLM that may include a question for the LLM to answer, a set of text-based instructions for the LLM to follow, or a combination of questions and instructions.

The maximum tokens for LLMs such as the OpenAI ChatGPT models range from 4097 to 32758 tokens, depending on the type of model being used. Presently, there are no best practice recommendations for token allocations among prompt types. As such the following conventions may be used as a general guideline for token allocation. Document chunk tokens may use 70% to 90%, taxonomy context tokens may use 8% to 28%, and LLM prompt tokens, including question, instruction, and other prompt words may use approximately 2%. Based on these conventions, for a maximum token limitation of 4,000 tokens: the document chunk may use 2,800 to 3,600 tokens, the taxonomy context may use 320 to 1120 tokens, and the LLM prompt may use up to 80 tokens. Alternately, based on these conventions, for a maximum token limitation of 16,000 tokens: the document chunk may use 11,200 to 14,400 tokens, the taxonomy context may use 1,280 to 4,480 tokens, and the LLM prompt may use up to 320 tokens. Large taxonomies may be larger than 4480 tokens, generally far larger.

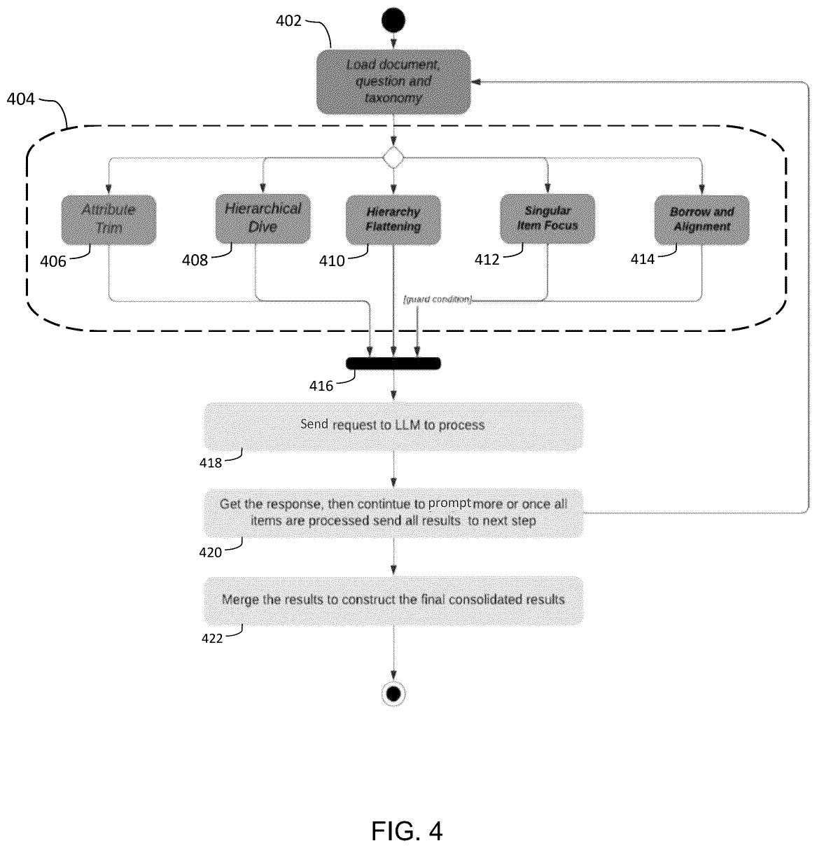

Referring now to FIG. 4, flow chart 400 depicting the implementation of taxonomy augmented generation (TAG) tactics with an LLM is provided. According to flow chart 400, implementation may begin by loading 402 the documents, taxonomy, and questions to be processed by the LLM. In some embodiments, questions may be accompanied by a set of clarifying instructions for the LLM to factor into the generated response. The implementation may then proceed by applying 404 at least one taxonomy augmented generation (TAG) tactic from a set of TAG tactics to the loaded documents, taxonomy, and questions to be processed by the LLM. In some embodiments, the set of TAG tactics may include: attribute trimming 406, hierarchical diving 408, hierarchy flattening 410, singular item focusing 412, and borrow and alignment 414. Applying one of the TAG tactics to the loaded documents, taxonomy, and questions may then output 416 a first prompt not exceeding the LLM's maximum token constraint. Once the first prompt has been output, it may be sent 418 over to the LLM for processing. The LLM may then generate 420 a response for the first prompt and depending on the document, question, and taxonomy that was loaded, or the TAG tactic that was applied one or more additional prompts may need to be sent to the LLM, and one or more additional responses may be generated. Finally, once the LLM has processed all required prompts, the implementation may merge 422 all of the responses into one consolidated final result to be presented to an end user.

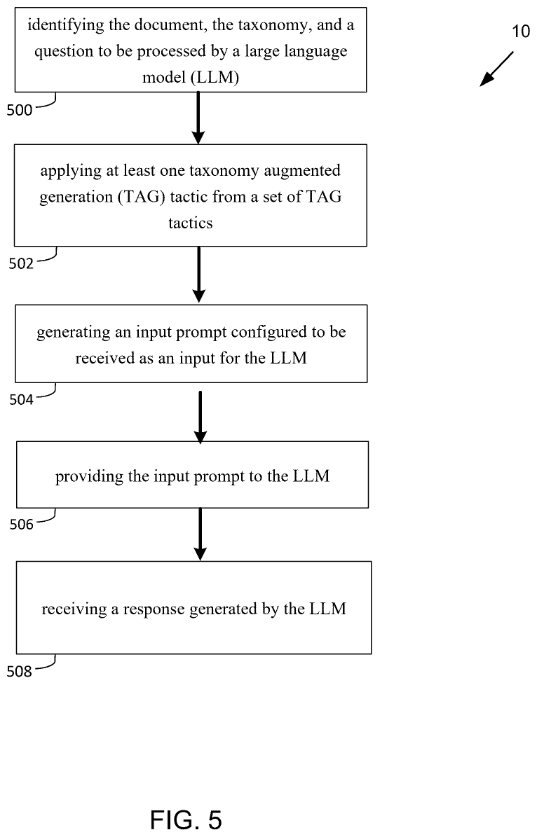

Referring now to FIG. 5, a flow chart depicting LLM-taxonomy process 10 is provided. According to the flow chart LLM-taxonomy process 10 may begin by identifying 500 the document, the taxonomy, and a question to be processed by a large language model (LLM), and proceed by applying 502 at least one taxonomy augmented generation (TAG) tactic from a set of TAG tactics. In some embodiments, the set of TAG tactics may include: attribute trimming, hierarchical diving, hierarchy flattening, singular item focusing, and borrowing alignment. LLM-taxonomy process 10 may then continue by generating 504 an input prompt configured to be received as an input by the LLM, where the input prompt includes a document context derived from the document, a taxonomy context derived from the taxonomy, and the question to be processed by the LLM. Once the input prompt has been generated, LLM-taxonomy process 10 may continue by providing 506 the input prompt to the LLM, and receiving 508 a response generated by the LLM. In some embodiments, each tactic of the set of TAG tactics may be configured to reduce the size of the input prompt for the LLM, such that the total combined size of the input prompt is less than the size of a maximum token constraint for the LLM.

In some embodiments, a taxonomy context may be very large and may not be packed into one LLM prompt. It may be large because some unnecessary attributes are included in the prompt. Some attributes are useful for human or business process purposes, but they may not be useful for an LLM to understand the taxonomy context. For example, in a taxonomy of government organizations, each element of the taxonomy may be a single government agency. Each element may include a description, and these descriptions may not be useful for the LLM to follow taxonomy-related instructions. The total word count of all the descriptions of government organization taxonomy may be more than 44,000 words, or roughly 59 k tokens, and may comprise the majority of the content. 59 k tokens may be well beyond the LLM prompt's token limit. The TAG tactic of attribute trimming may remove unnecessary attributes before constructing the prompt to LLM in order to reduce the number of tokens used by the taxonomy context in the LLM prompt.

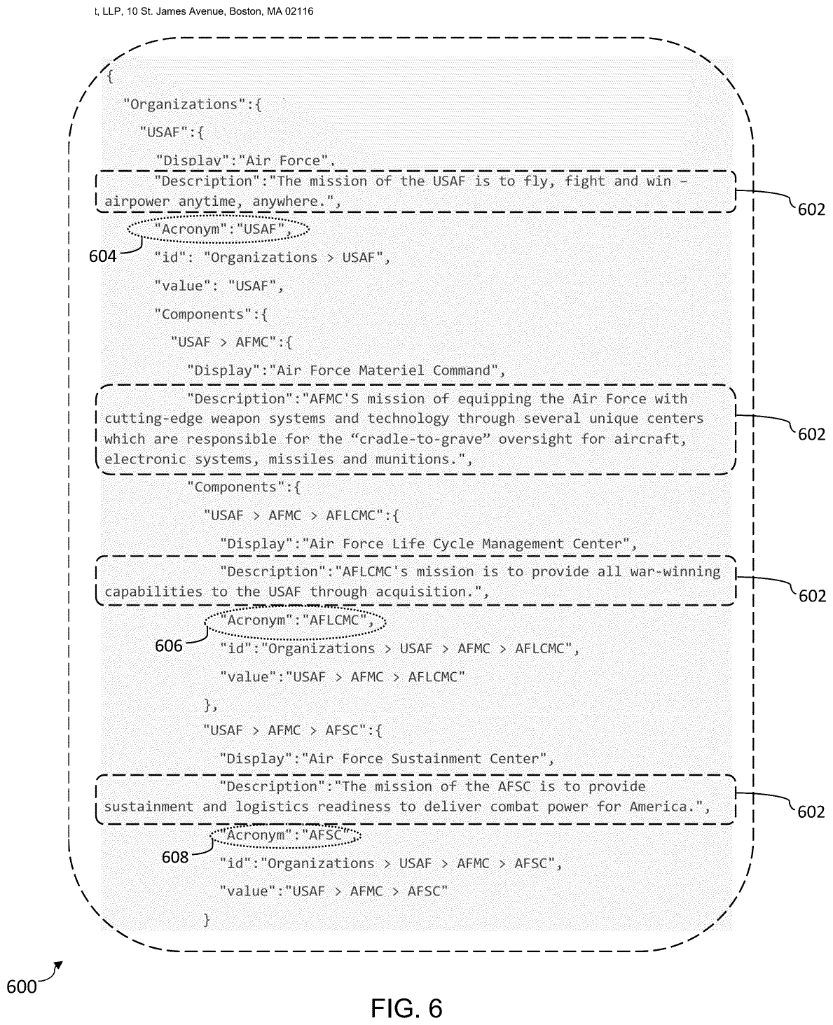

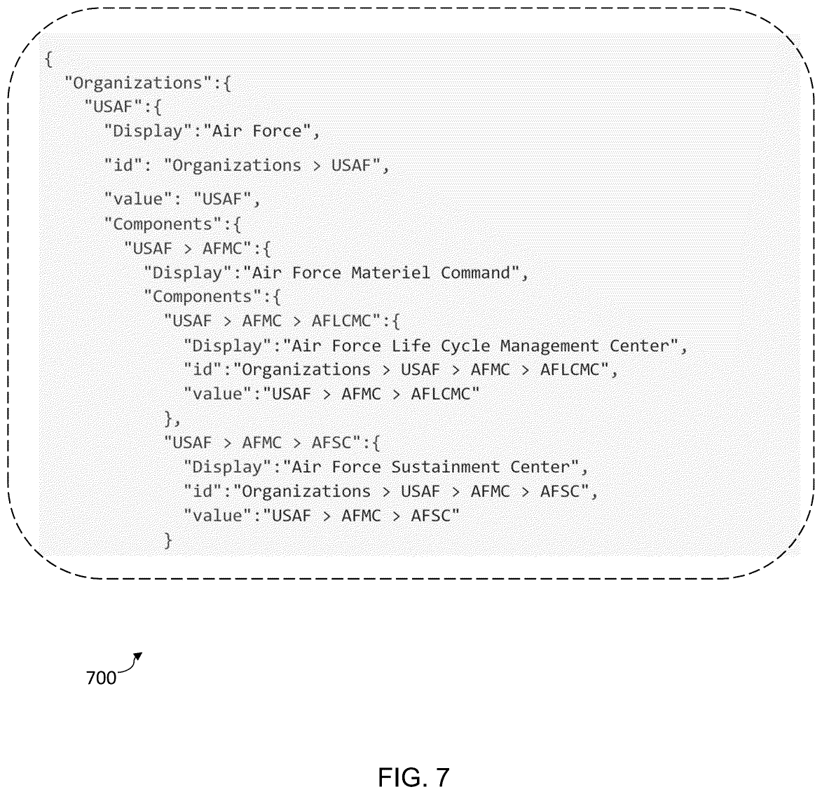

Referring now to FIGS. 6-7, unabbreviated taxonomy context 600 and abbreviated taxonomy context 700 are provided. Unabbreviated taxonomy context 600 may include one or more human-specific attributes, such as a plurality of descriptions 602 and acronyms 604, 606, 608. Applying the attribute trimming TAG tactic removes one or more user-designated attributes from the taxonomy context before the input prompt is generated. In this example, an end-user may apply attribute trimming to remove plurality of descriptions 602 and acronyms 604, 606, 608 from unabbreviated taxonomy context 600 to generate abbreviated taxonomy context 700. The original javascript object notation (JSON) in unabbreviated taxonomy context 600 has 138 words, and the attribute trimmed version in abbreviated taxonomy context 700 only has 50 words. JSON refers to an open standard file format and data interchange format that uses human-readable text to store and transmit data objects consisting of attribute-value pairs and arrays.

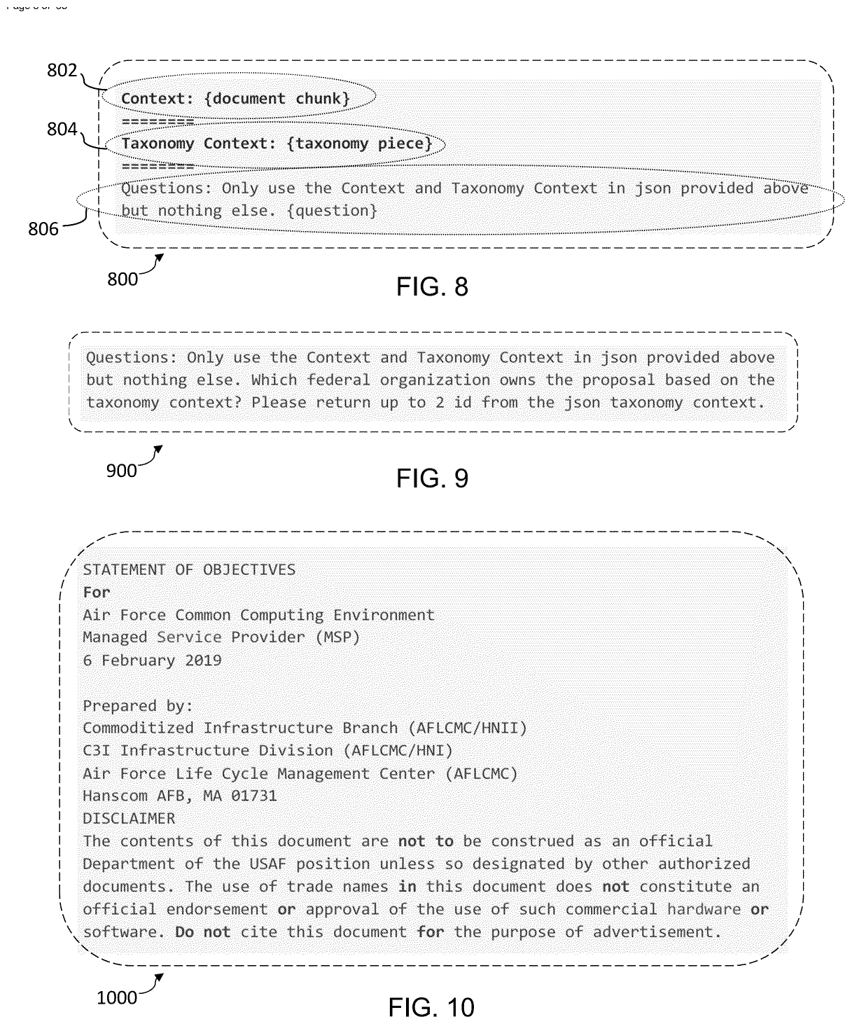

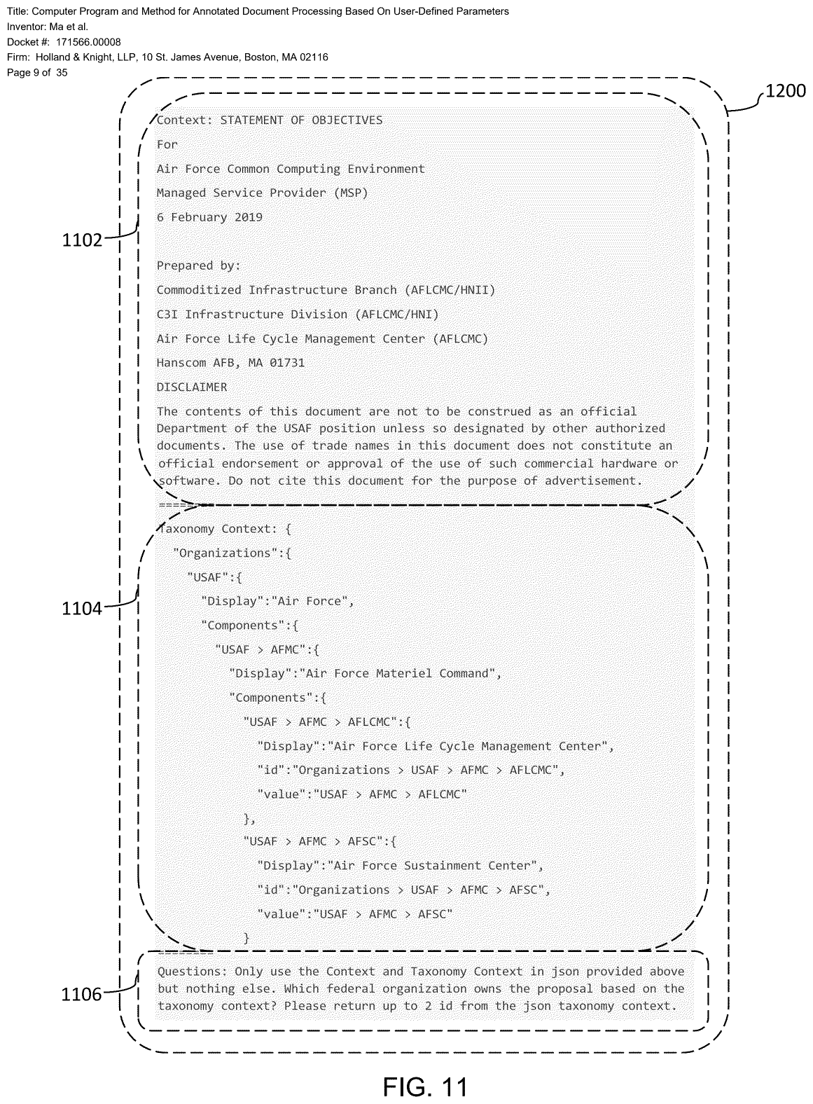

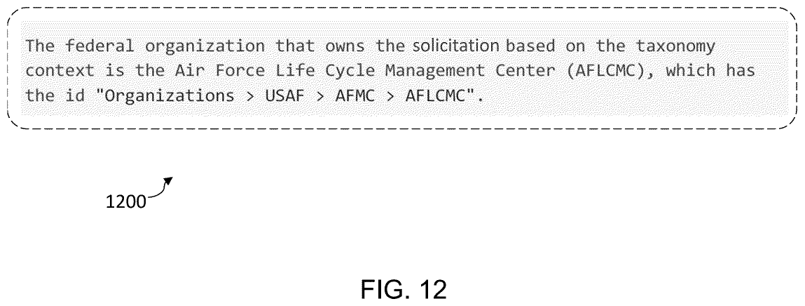

Referring now to FIGS. 8-12, unpopulated template 800, question 900, document context 1000, LLM prompt 1100, and LLM response 1200 are provided. Unpopulated template 800 may include document context 802, taxonomy context 804, and question portion 806. Context portion 802 serves as a placeholder for document context 1000 (also called a document chunk) which may refer to a piece of the document processed by the retrieval augmented generation (RAG) method or a document batch chunking method (as described in FIG. 3). Taxonomy context 804 may refer to a piece of the taxonomy that may be small enough to be added to LLM prompts, such as the previously discussed abbreviated taxonomy context 700. Question portion 806, may include additional clarifying JSON instructions for the LLM but may primarily serve as a placeholder for user-defined question 800 that may be presented to the LLM for processing. LLM prompt 1100 may represent the combination of document context 1000, abbreviated taxonomy context 700, and question 900 in one consolidated text-based input for the LLM to process. Once received and processed by the LLM, LLM response 1200 may be produced as an answer to question 900 in the context of the document and the taxonomy selected by the end user.

In some embodiments, a taxonomy may be hierarchical and the TAG tactic of hierarchical diving may be applied. Under hierarchical diving, instead of constructing a prompt having full taxonomy items, multiple prompts may be generated and sent to an LLM for processing starting from a top-level taxonomy and diving into sub-level nodes, where each prompt would only contain the taxonomy context from the same level.

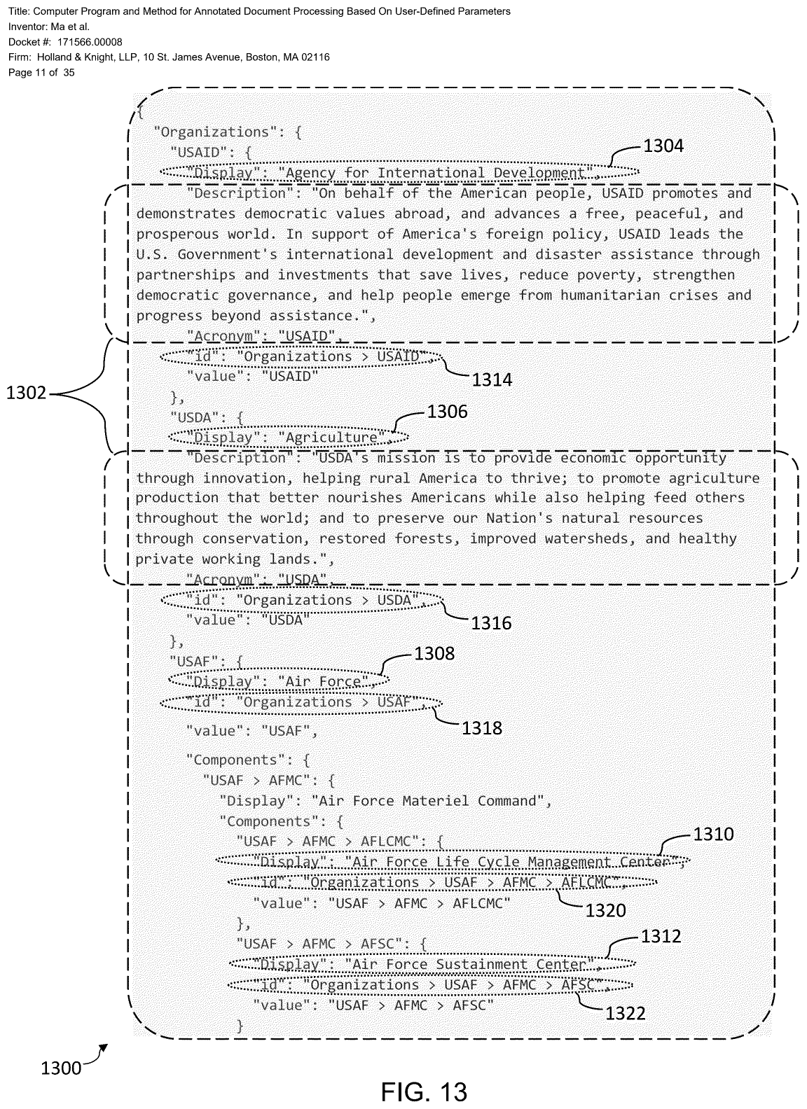

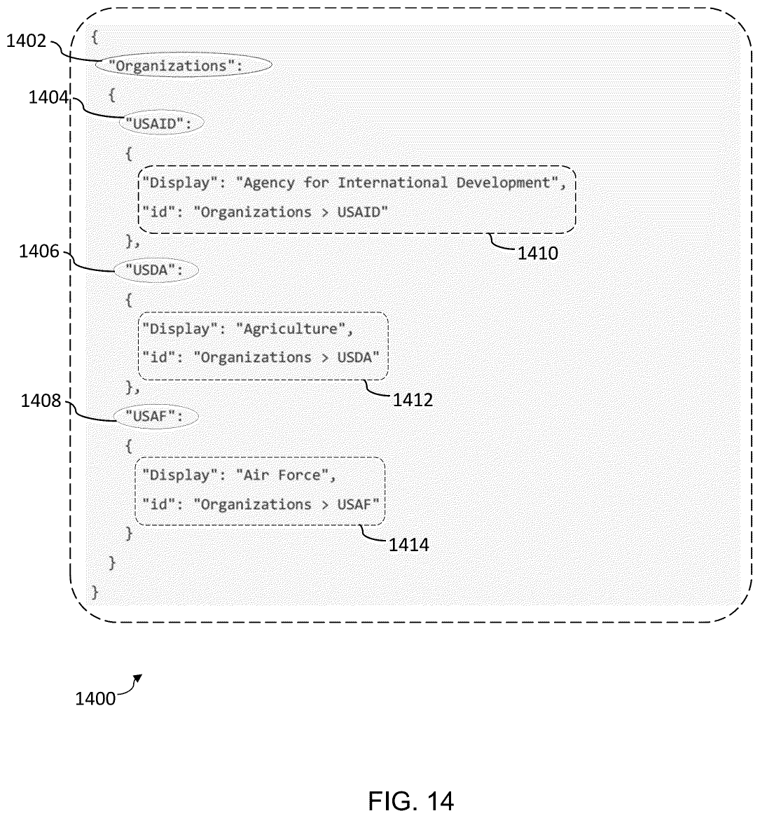

Referring now to FIGS. 13-14, unabbreviated taxonomy context 1300, and abbreviated taxonomy context 1400 are provided. Unabbreviated taxonomy context 1300 may include one or more human-specific attributes, such as a plurality of descriptions and acronyms 1302, display tags 1304, 1306, 1308, 1310, 1312, and ID tags 1314, 1316, 1318, 1320, 1322. Applying the attribute trimming TAG tactic removes one or more user-designated attributes from the taxonomy context before the input prompt is generated. In this example, an end-user may apply attribute trimming before applying hierarchical diving to remove plurality of descriptions and acronyms 1302 from unabbreviated taxonomy context 1300 to generate abbreviated taxonomy context 1400. Abbreviated taxonomy context 1400 may more clearly illustrate the hierarchical structure of each organizational sub-group 1402, 1404, 1406, 1408 and their corresponding display tags and ID tags 1410, 1412, 1414.

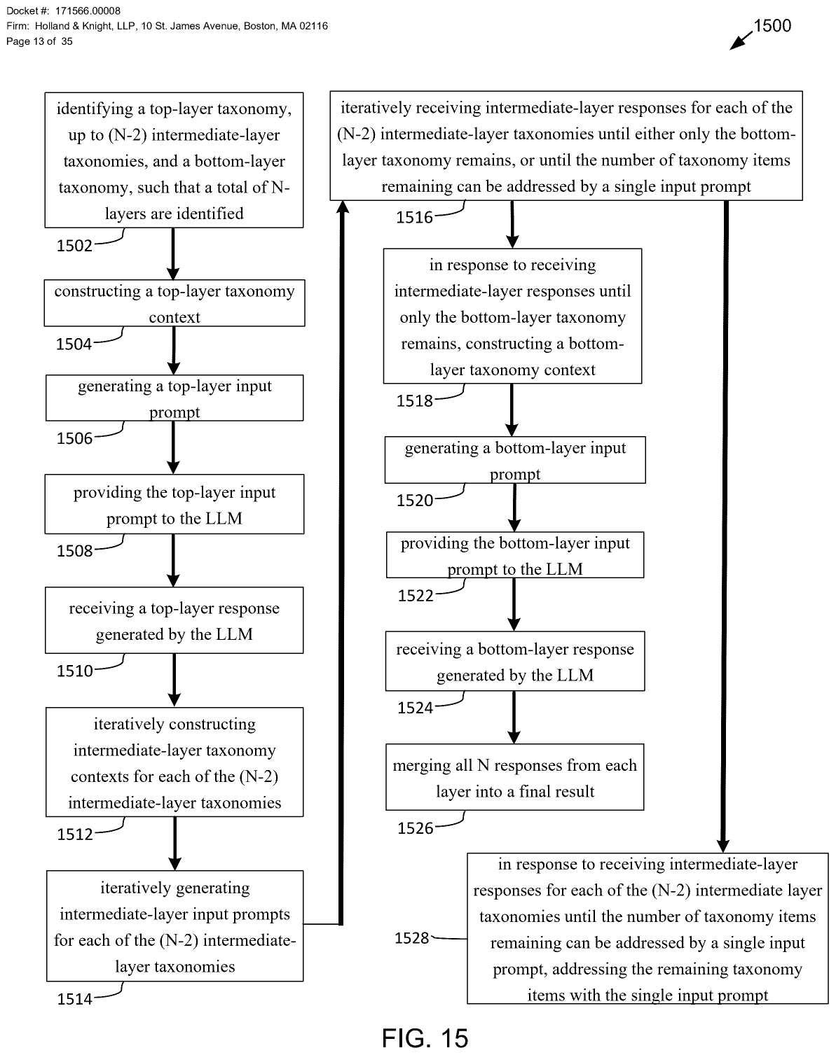

Referring now to FIG. 15, flow chart 1500 describing the application of the hierarchical diving TAG tactic is provided. According to flow chart 1500, the hierarchical diving TAG tactic may begin by identifying 1502 a top-layer taxonomy, up to (N−2) intermediate layer taxonomies, and a bottom-layer taxonomy, such that a total of N-layers are identified, and proceed by constructing 1504 a top-layer taxonomy context by generating 1506 a top-layer input prompt, providing 1508 the top-layer input prompt to the LLM, and receiving 1510 a top-layer response generated by the LLM. Then for each of the (N−2) intermediate-layer taxonomies, the hierarchical diving TAG tactic may proceed by iteratively: constructing 1512 intermediate-layer taxonomy contexts, generating 1514 intermediate-layer input prompts, and receiving 1516 intermediate-layer responses until either the number of taxonomy items left may be addressed by a single input prompt, or until only the bottom layer taxonomy remains. Hierarchical diving TAG tactic may then proceed by constructing 1518 a bottom-layer taxonomy context, generating 1520 a bottom-layer input prompt, providing 1522 the bottom-layer input prompt to the LLM, and receiving 1524 a bottom-layer response generated by the LLM. Finally, the hierarchical diving TAG tactic may conclude by merging 1526 all N responses from each layer into one comprehensive response. In some embodiments, in response to receiving intermediate-layer responses for each of the (N−2) intermediate layer taxonomies until the number of taxonomy items remaining may be addressed by a single input prompt, the hierarchical diving TAG tactic may then proceed by addressing 1528 the remaining taxonomy items with the single input prompt.

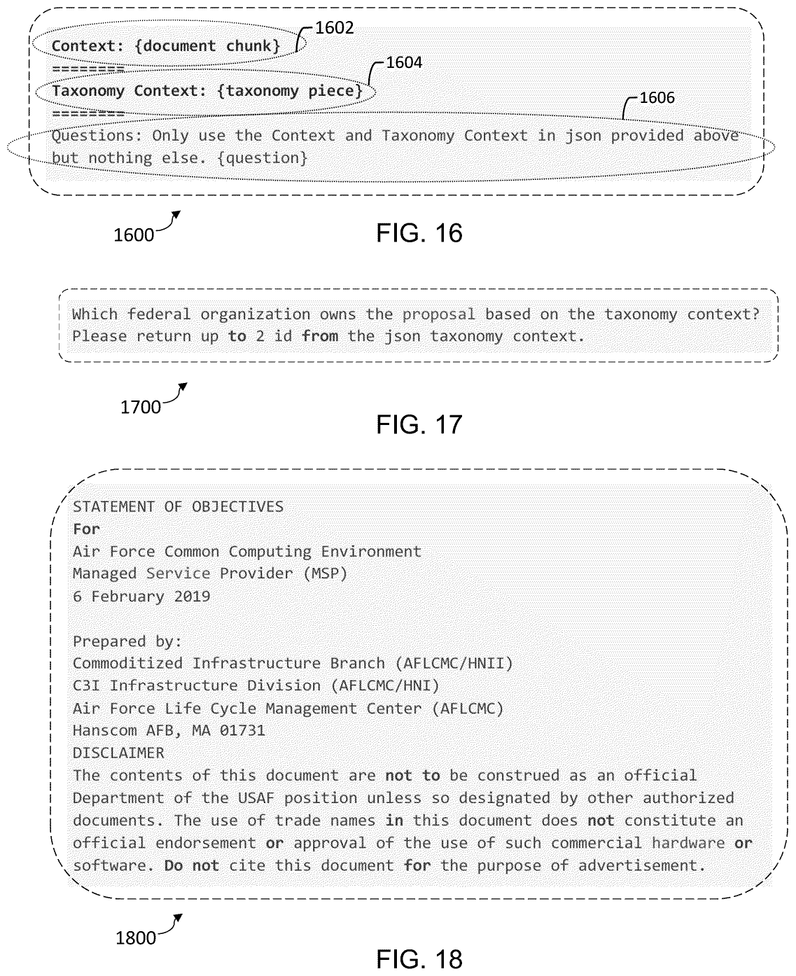

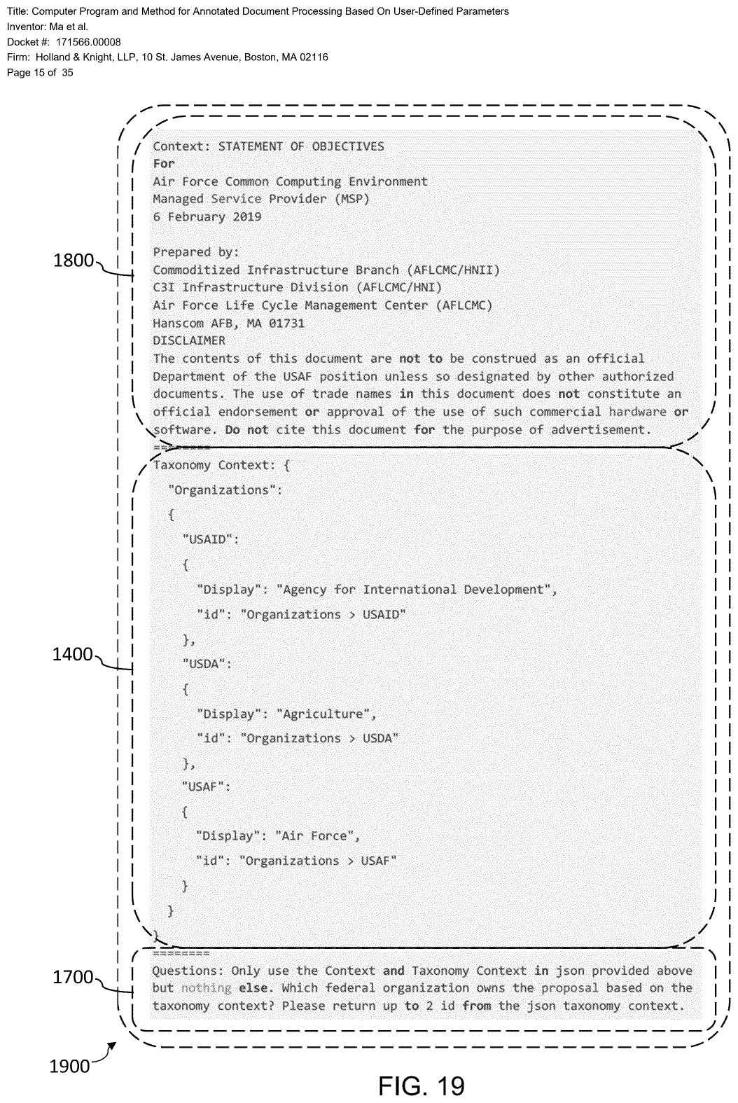

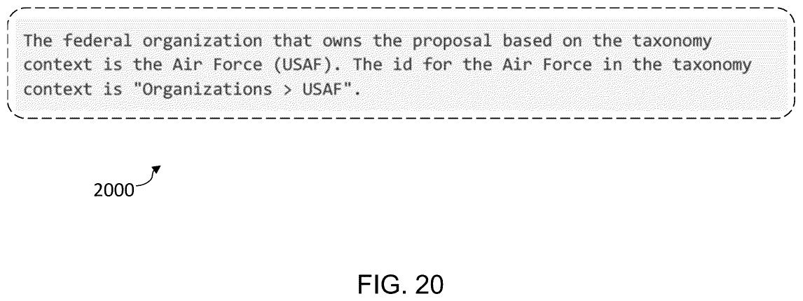

Referring now to FIGS. 16-21, unpopulated template 1600, question 1700, document context 1800, LLM prompt 2000, and LLM response 2100 are provided. Unpopulated template 1600 may include document context 1602, taxonomy context 1604, and question portion 1606. Context portion 1602 may serve as a placeholder for document context 1800 which may refer to a piece of the document processed by the retrieval augmented generation (RAG) method or a document batch chunking method (as described in FIG. 3). Taxonomy context 1604 may refer to a piece of the taxonomy that may be small enough to be added to LLM prompts, such as the previously discussed abbreviated taxonomy context 1400. Question portion 1606, may include additional clarifying JSON instructions for the LLM but may primarily serve as a placeholder for user-defined question 1700 that may be presented to the LLM for processing. LLM prompt 1900 may represent the combination of document context 1800, abbreviated taxonomy context 1400, and question 1700 in one consolidated text-based input for the LLM to process. Once received and processed by the LLM, LLM response 2000 may be produced as an answer to question 1700 in the context of the document and the taxonomy selected by the end user. LLM response 2000 shows that the correct top-level taxonomy item is interpreted and provided by the LLM. The next steps of iteratively constructing sub-level prompts, providing sub-level prompts to the LLM, and receiving sub-level responses for each of the (N−2) intermediate layers and the bottom layer may then proceed as shown in flow chart 1500 describing the application of the hierarchical diving TAG tactic.

In some embodiments, a taxonomy may be hierarchical and the TAG tactic of hierarchical flattening may be applied. When the taxonomy context is very large and has multiple levels of hierarchy structures, even an LLM that is aware of JSON format may become confused with the structure and misunderstand the hierarchy. Under hierarchical flattening, instead of presenting a complicated JSON or comma-separated value (CSV) structure that is hard to follow by the LLM, hierarchical flattening may use taxonomy element IDs that each contain the hierarchy information of what is above the element. These hierarchical taxonomy element IDs may prove easier for the LLM to understand.

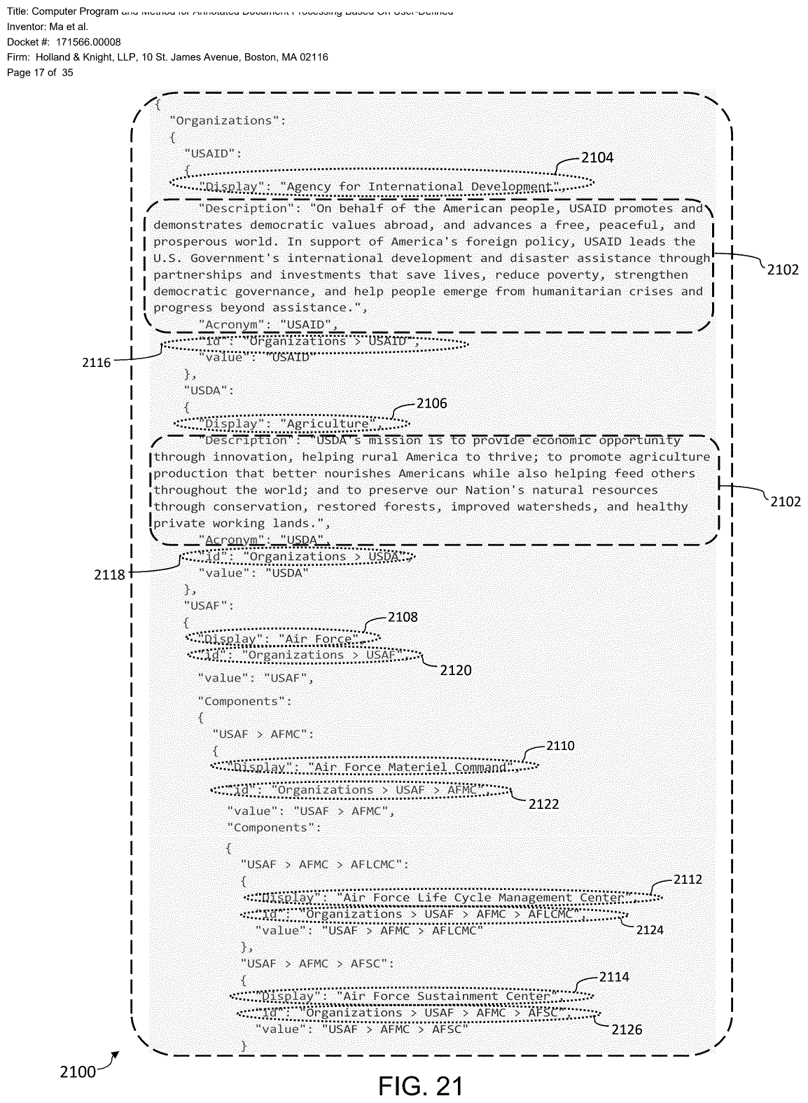

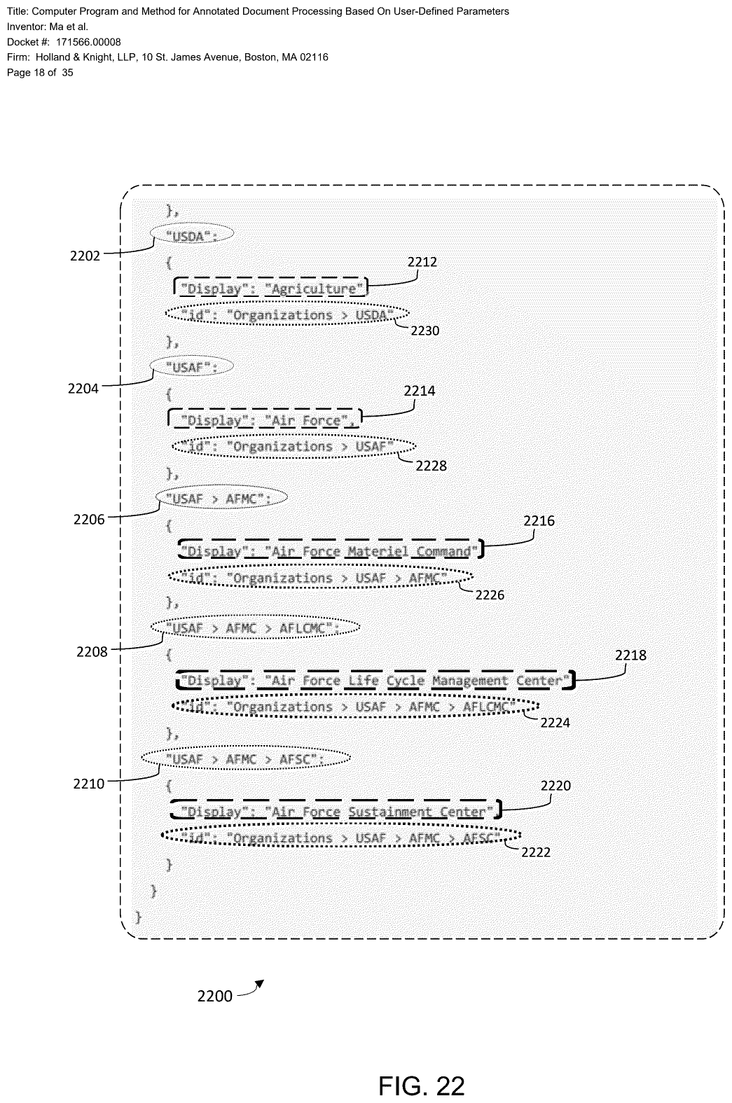

Referring now to FIGS. 21-22, unabbreviated taxonomy context 2100, and abbreviated taxonomy context 2200 are provided. Unabbreviated taxonomy context 2100 may include one or more human-specific attributes, such as a plurality of descriptions and acronyms 2102, display tags 2104, 2106, 2108, 2110, 2112, 2114, and ID tags 2116, 2118, 2120, 2122, 2124, 2126. Applying the attribute trimming TAG tactic may remove one or more user-designated attributes from the taxonomy context before the input prompt is generated. In this example, an end-user may apply attribute trimming before applying hierarchical flattening to remove plurality of descriptions and acronyms 2102 from unabbreviated taxonomy context 2100 to generate abbreviated taxonomy context 2200. Abbreviated taxonomy context 2200 may more clearly illustrate the hierarchical structure of each organizational sub-group 2202, 2204, 2206, 2208, 2210, their corresponding display tags 2212, 2214, 2216, 2218, 2220, and ID tags, 2222, 2224, 2226, 2228, and 2230. Further, after applying the hierarchical flattening TAG tactic, abbreviated taxonomy context 2200 shows where each of ID tags, 2222, 2224, 2226, 2228, 2230 include hierarchical information about the superseding layers above. For example, ID tag 2228 reads “id”: “Organizations>USAF>AFMC>AFSC” for the Air Force Sustainment Center, and ID tag 2226 reads “id”: “Organizations>USAF>AFMC>AFLCMC” for the Air Force Life cycle Management Center. Accordingly, ID tags 2222, 2224 may be understood to be on the same hierarchical level, where both sub-groups sit below ID tag 2226 which reads “id”: “Organizations>USAF>AFMC” for the Air Force Material Command. ID tag 2226 in turn sits below ID tag 2228 which reads “id”: “Organizations>USAF” for the United States Air Force.

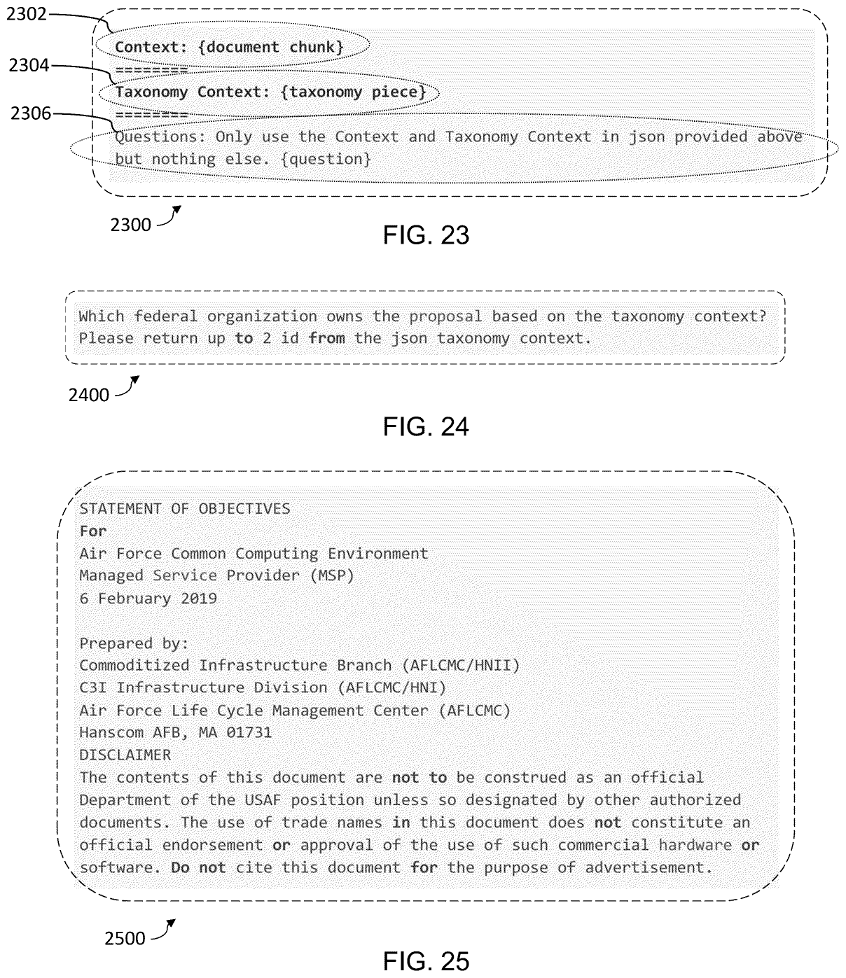

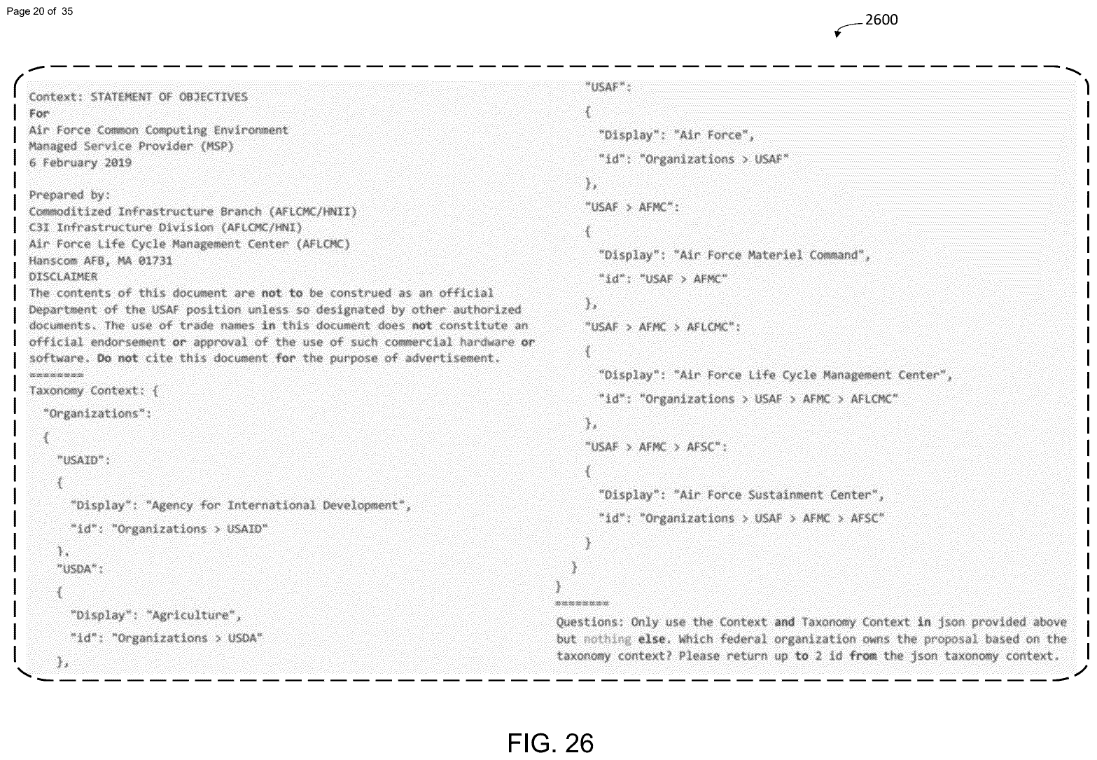

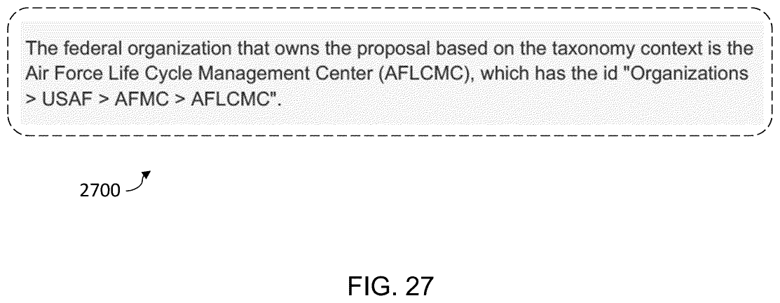

Referring now to FIGS. 23-27, unpopulated template 2300, question 2400, document context 2500, LLM prompt 2600, and LLM response 2700 are provided. Unpopulated template 2300 may include document context 2302, taxonomy context 2304, and question portion 2306. Context portion 2302 may serve as a placeholder for document context 2500 which may refer to a piece of the document processed by the retrieval augmented generation (RAG) method or a document batch chunking method (as described in FIG. 3). Taxonomy context 2304 may refer to a piece of the taxonomy that may be small enough to be added to LLM prompt 2600, such as the previously discussed abbreviated taxonomy context 2300. Question portion 2306, may include additional clarifying JSON instructions for the LLM but may primarily serve as a placeholder for user-defined question 2400 that may be presented to the LLM for processing. LLM prompt 2600 may represent the combination of document context 2500, abbreviated taxonomy context 2200, and question 2400 in one consolidated text-based input for the LLM to process. Once received and processed by the LLM, LLM response 2700 may be produced as an answer to question 2400 in the context of the document and the taxonomy selected by the end user.

In some embodiments, LLM-taxonomy process 10 may encounter a highly customized taxonomy that may include a large text description too large for the LLM to follow, in such instances the TAG tactic of singular item focusing may be applied. Singular item focusing may construct one prompt with only one taxonomy item with all the attributes needed within it. More specifically, single-item focusing may break down the taxonomy to a single-item level and construct a prompt with just one taxonomy item. If there are N elements in a taxonomy, single-item focusing may construct N prompts and sends them each to LLM one by one, and when N LLM responses are generated, single-item focusing merges them all into one comprehensive result. This solution may only work if every taxonomy element's context is small enough. Therefore, this tactic may be best used for a taxonomy with very large single-item attributes. In order to fit the taxonomy into limited space, time is sacrificed and instead of one or a few prompts, N prompts may be submitted for N items.

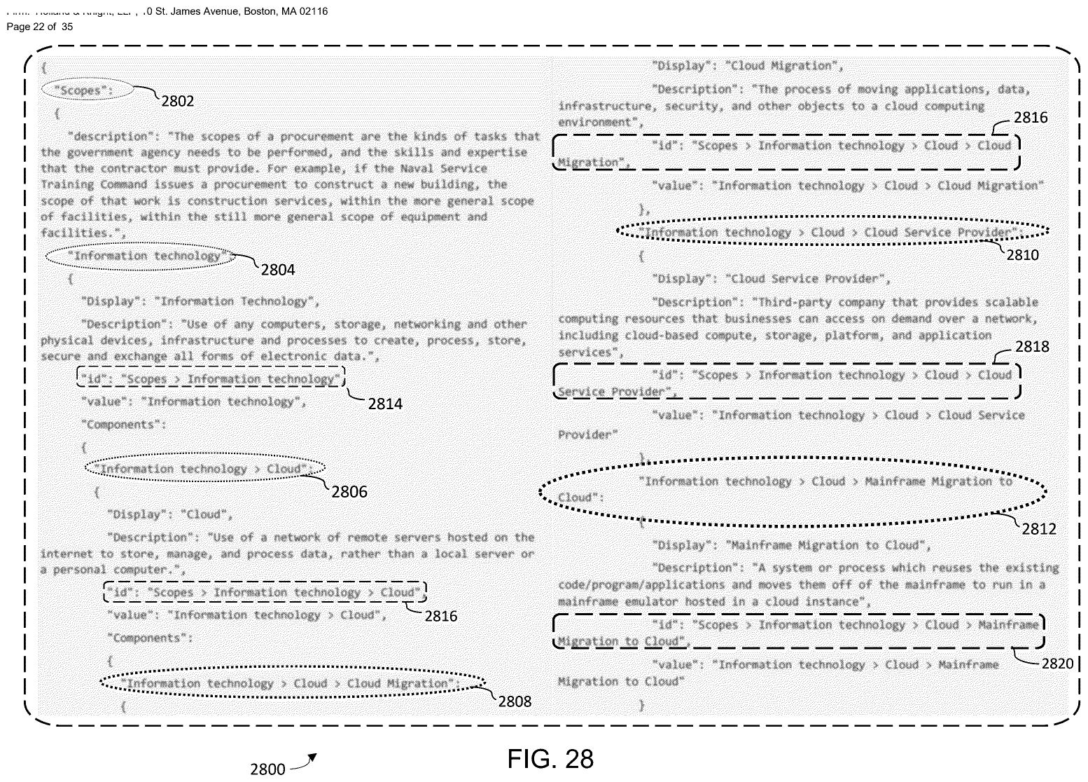

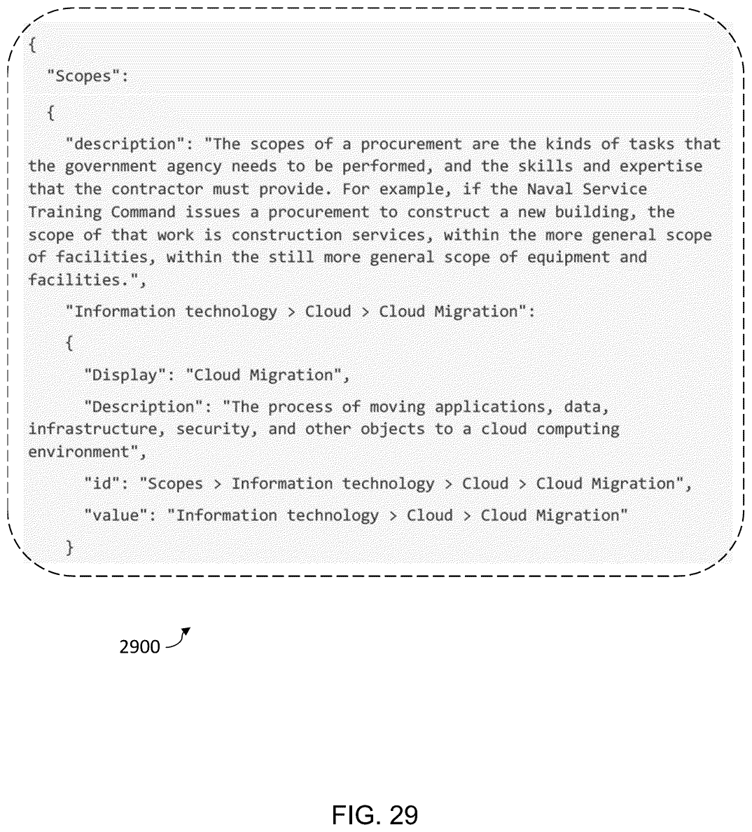

Referring now to FIGS. 28-29, unabbreviated taxonomy context 2800, and abbreviated taxonomy context 2900 are provided. Unabbreviated taxonomy context 2800 may include a plurality of well-defined elements 2802, 2804, 2806, 2808, 2810, 2812 that may each be separately processed by the LLM. However, applying the hierarchical flattening TAG tactic in addition to applying single-item focusing, may include hierarchical information about the superseding layers above each of ID tags, 2814, 2816, 2818, 2820 2822 to further clarify the relationship between each of the plurality of well-defined elements 2802, 2804, 2806, 2808, 2810, 2812.

Applying the single-item focusing TAG tactic may extract one item from the scope taxonomy to focus on when generating abbreviated taxonomy context 2900. In this instance, the single-item focusing tag tactic may have focused on element 2808 which may refer to “Information Technology>Cloud>Cloud Migration” under the scope taxonomy when generating abbreviated taxonomy context 2900. Instead of removing attributes like the descriptions and acronyms, the single-item focusing TAG tactic may leave the attributes untouched, but may only show the attributes for a single selected element, thereby accomplishing a similarly abbreviated taxonomy context 2900 by a different method.

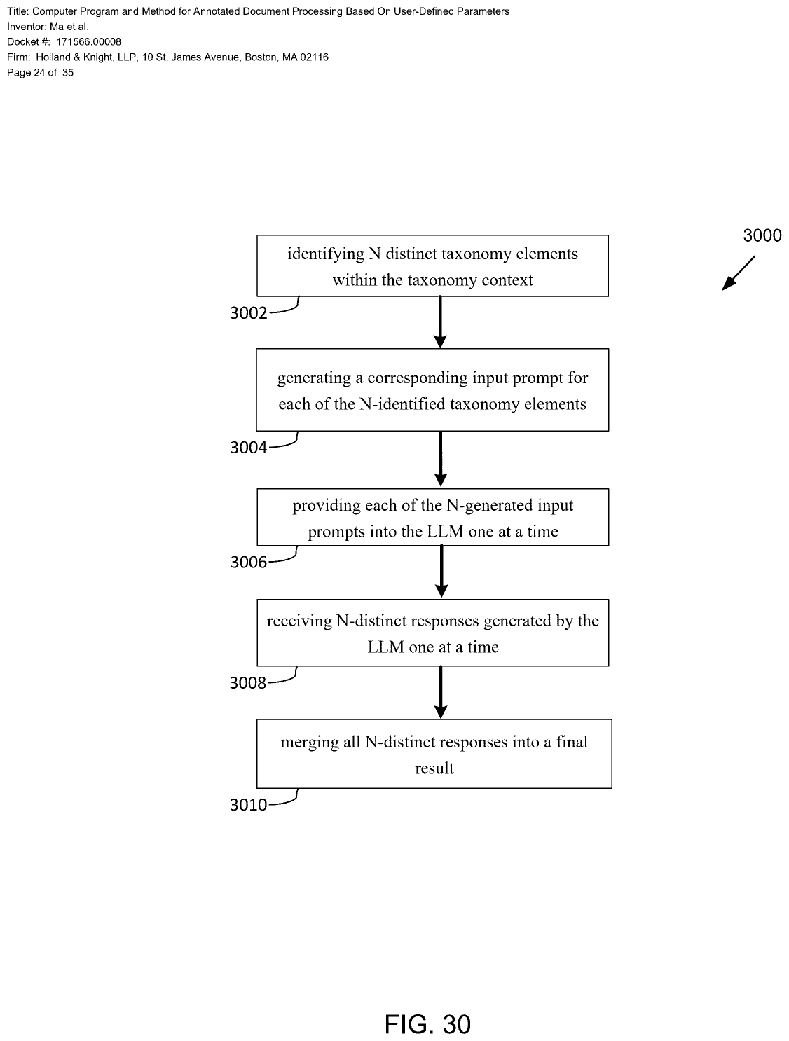

Referring now to FIG. 30, flow chart 3000 describing the application of the single-item focusing TAG tactic is provided. According to flow chart 3000, the single-item TAG tactic may begin by identifying 3002 N distinct taxonomy elements within the taxonomy context and generating 3004 a corresponding input prompt for each of the N-identified taxonomy elements. Single-item focusing TAG tactic may then proceed by providing 3006 each of the N-generated input prompts into the LLM one at a time, and receiving 3008 N-distinct responses generated by the LLM one at a time. Finally, the single-item focusing TAG tactic may conclude by merging 3010 all N responses from each layer into one comprehensive response.

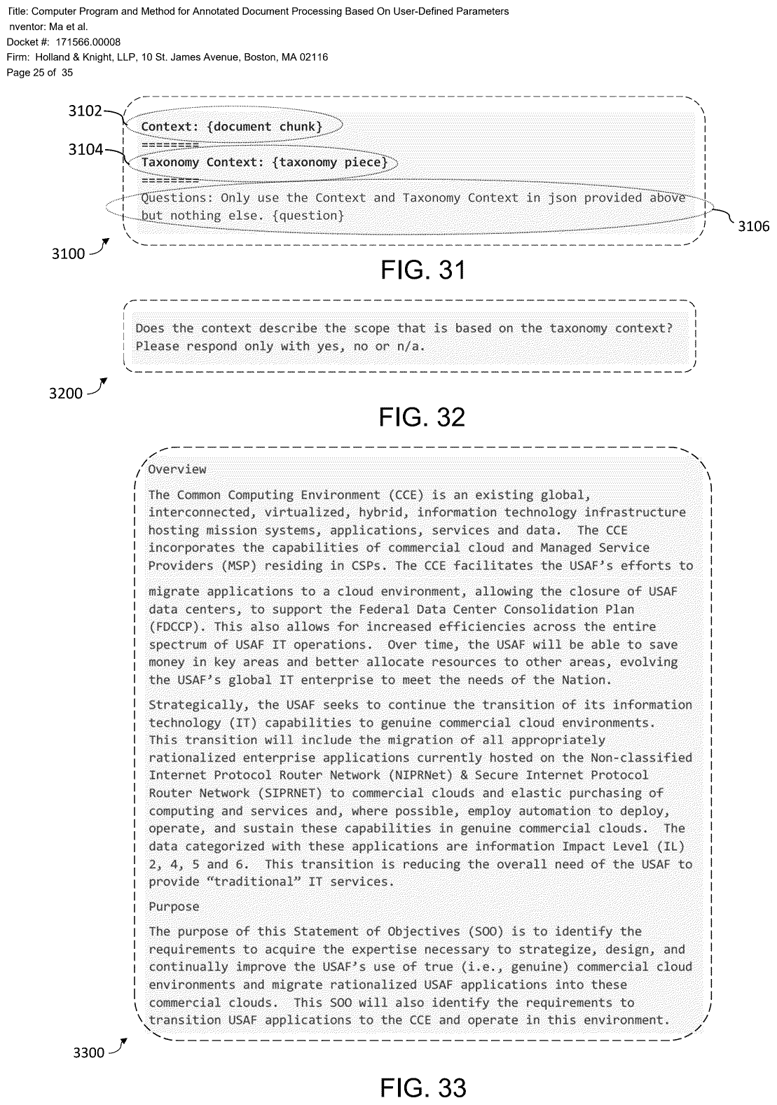

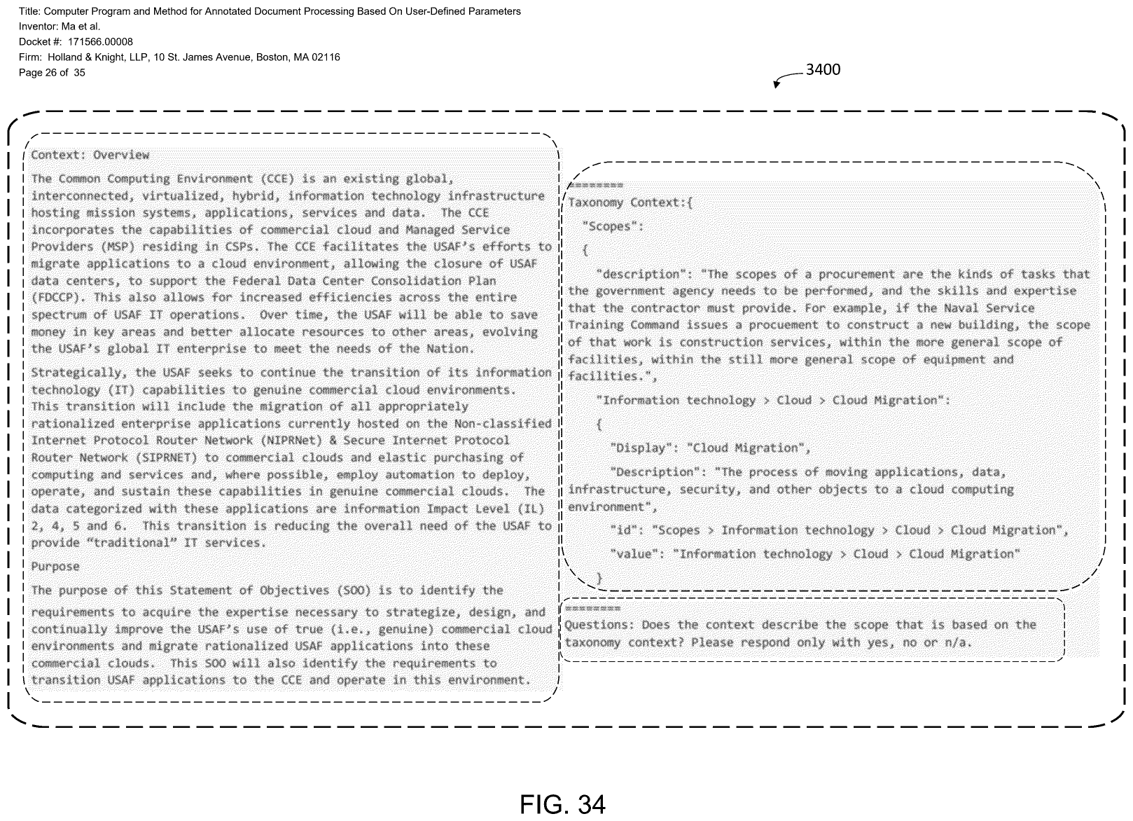

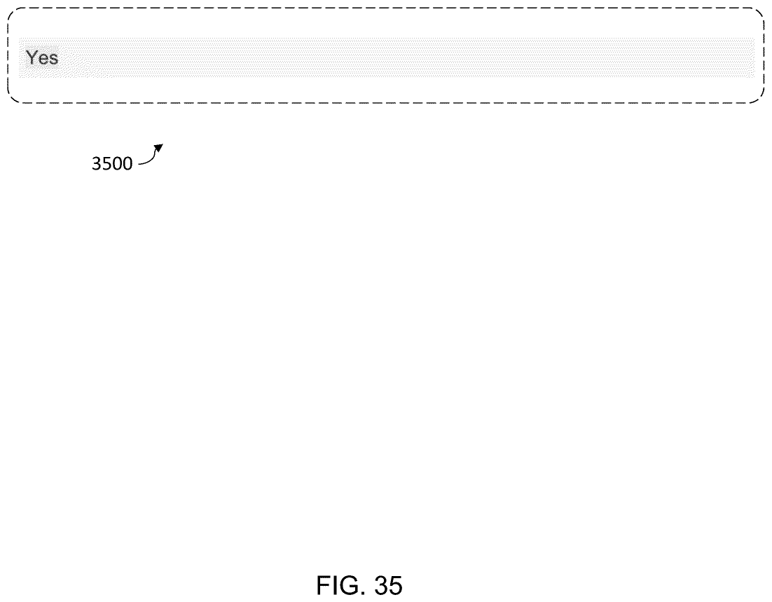

Referring now to FIGS. 31-35, unpopulated template 3100, question 3200, document context 3300, LLM prompt 3400, and LLM response 3500 are provided. Unpopulated template 3100 may include document context 3102, taxonomy context 3104, and question portion 3106. Context portion 3102 may serve as a placeholder for document context 3300 which may refer to a piece of the document processed by the retrieval augmented generation (RAG) method or a document batch chunking method (as described in FIG. 3). Taxonomy context 3104 may refer to a piece of the taxonomy that may be small enough to be added to LLM prompts, such as the previously discussed abbreviated taxonomy context 2900. Question portion 3106, may include additional clarifying JSON instructions for the LLM but may primarily serve as a placeholder for user-defined question 3200 that may be presented to the LLM for processing. LLM prompt 3400 may represent the combination of document context 3300, abbreviated taxonomy context 2900, and question 3200 in one consolidated text-based input for the LLM to process.

Once received and processed by the LLM, LLM response 3500 may be produced as an answer to question 3200 in the context of the document and the taxonomy selected by the end user. LLM response 3500 shows a correct response for the first selected taxonomy element 2808 of the plurality of taxonomy elements 2802, 2804, 2806, 2808, 2810, 2812. The following steps of generating 3004 a corresponding input prompt for each of the N-identified taxonomy elements, providing 3006 each of the N-generated input prompts into the LLM one at a time, receiving 3008 N-distinct responses generated by the LLM one at a time, and merging 3010 all N responses from each of the plurality of taxonomy elements into one comprehensive response may then proceed as shown in flow chart 3000 describing the application of the single-item focusing TAG tactic.

In some embodiments, LLM-taxonomy process 10 may encounter an LLM that happens to be trained using similar knowledge to that contained in the taxonomy of interest, in such instances the TAG tactic of borrowing alignment may be applied. The TAG tactic of borrowing alignment may borrow/rely on previously obtained knowledge from the LLM and allow the LLM to respond with knowledge it has already trained for without the need to provide additional contextual information in the prompt. After the response, the TAG tactic of borrowing alignment may align the result with the taxonomy of interest by using a searching and mapping process.

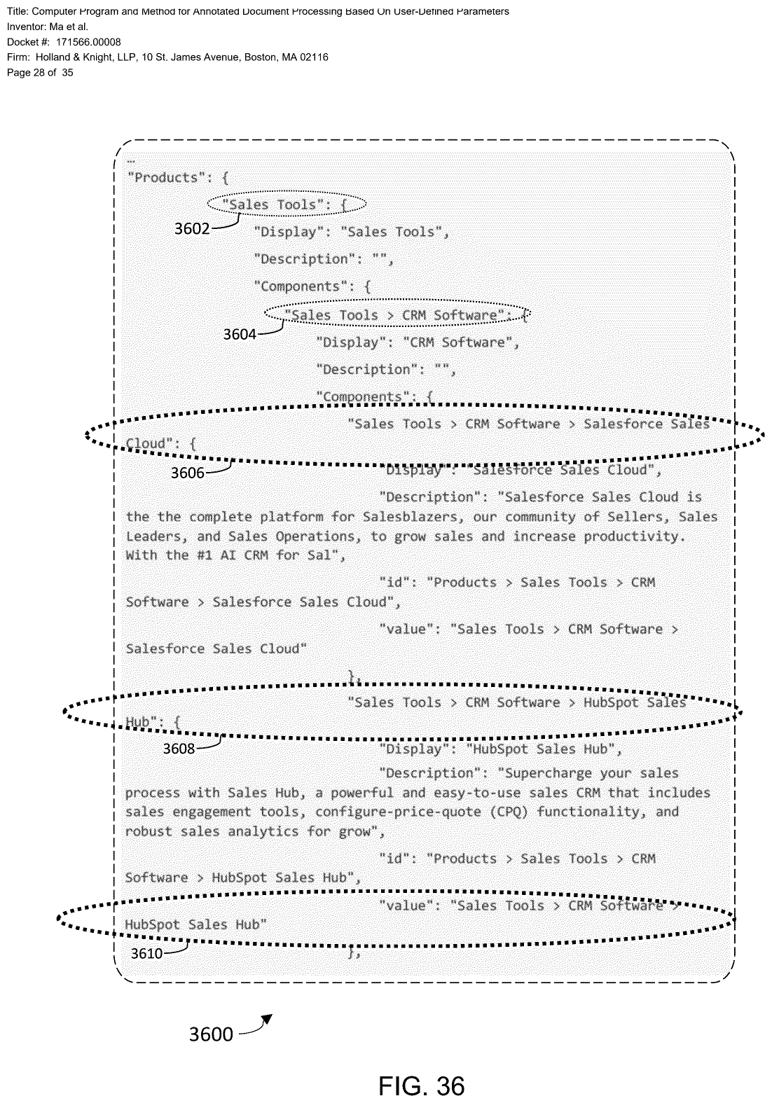

Referring now to FIG. 36, unabbreviated taxonomy context 3600 is provided. Unabbreviated taxonomy context 3600 may define a 3-layered hierarchical structure including top layer 3602, intermediate layer 3604, and a bottom layer with three elements 3606, 3608, 3610. The TAG tactic of borrowing alignment may not need to include unabbreviated taxonomy context 3600 in an LLM prompt to be processed by the LLM, because the LLM in this instance may have already received similar knowledge from previous training. More specifically, unabbreviated taxonomy context 3600 may be a product taxonomy containing around 4000 pages of text data roughly based on the software and categories from g2.com, where the OpenAI GPT 4 LLM to be used may have previously received training with data from g2.com.

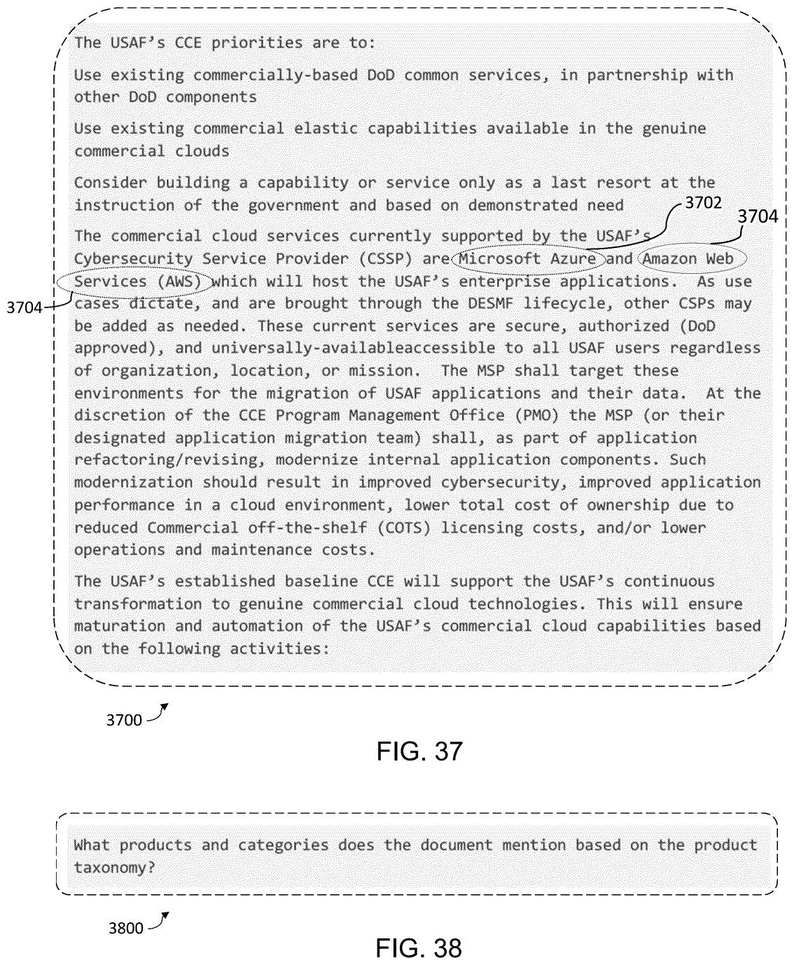

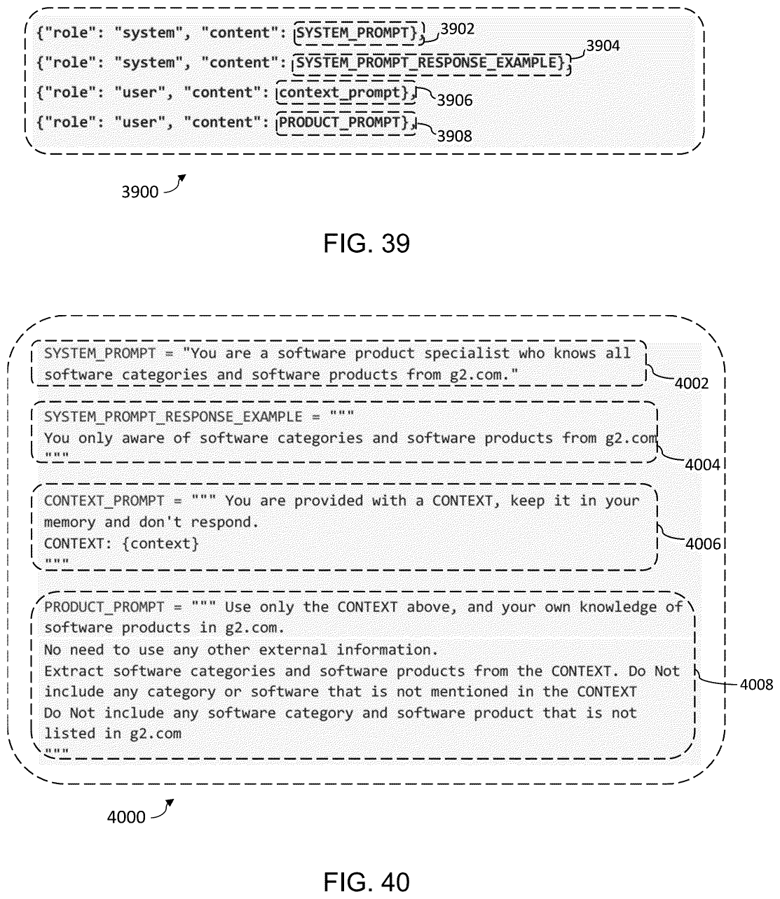

Referring now to FIGS. 37-40, document context 3700, question 3800, unpopulated LLM prompt template 3900 for chat endpoint, and definition page 4000 are provided. Document context 3700 may have been extracted from a document using retrieval augmented generation (RAG), batch chunking, or other methods. Further, document context 3700 may include taxonomy-related items 3702, 3704 for “Microsoft Azure” and “Amazon Web Services (AWS)” respectively. Question 3800 may have been crafted to identify products mentioned in unabbreviated taxonomy context 3700. Unpopulated LLM prompt template 3900 may be defined for a chat interface, such that TAG tactic borrowing alignment may be implemented through a large language model (LLM) artificial intelligence (AI)-based question-and-answer (Q&A) process. Unpopulated prompt template 3900 may include placeholders 3902, 3904, 3906, 3908, where definitions page 4000 may include prompt definitions 4002, 4004, 4006, 4008 that may be provided for each placeholder included in unpopulated prompt template 3900. Further, the LLM Q&A process may differ from the completion endpoint interface presented in previous examples, because the LLM Q&A process may allow for a more dynamic back-and-forth interaction between end-users and the LLM. Although the previously presented completion endpoint interfaces may allow for end-user customization, they require end-users to more directly edit the LLM prompts, where the LLM Q&A process relies on the LLM to generate an LLM prompt based on responses provided by the end-user through a chat interface.

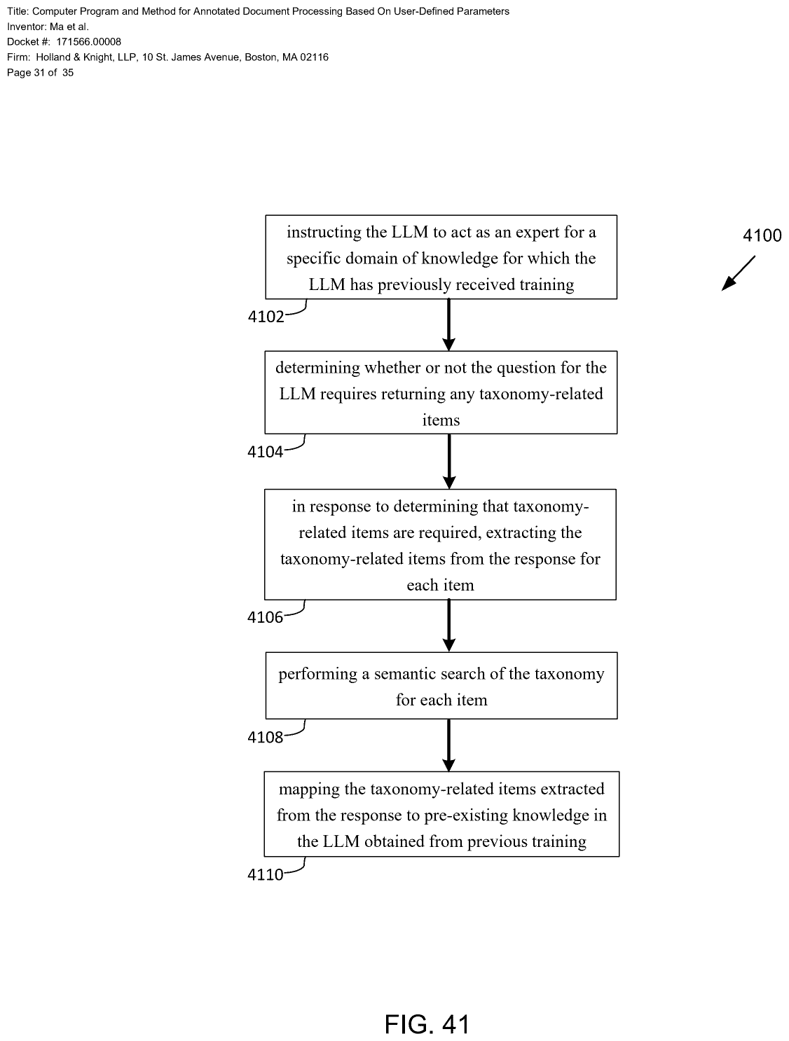

Referring now to FIG. 41, flow chart 4100 describing the application of the borrowing alignment TAG tactic is provided. According to flow chart 4100, the borrowing alignment TAG tactic may begin by instructing 4102 the LLM to act as an expert for a specific domain of knowledge for which the LLM has previously received training, where the specific domain of knowledge encompasses one or more scopes of the taxonomy associated with question 3800. The borrowing alignment TAG tactic may proceed by determining 4104 if the question to be submitted to the LLM requires returning any taxonomy-related items. Then, in response to determining that taxonomy-related items are required, extracting 4106 the taxonomy-related items from the response for each item, and performing 4108 a semantic search of the taxonomy for each item. Finally, the borrowing alignment TAG tactic may conclude by mapping 4110 the taxonomy-related items from the response to pre-existing knowledge obtained from previous training.

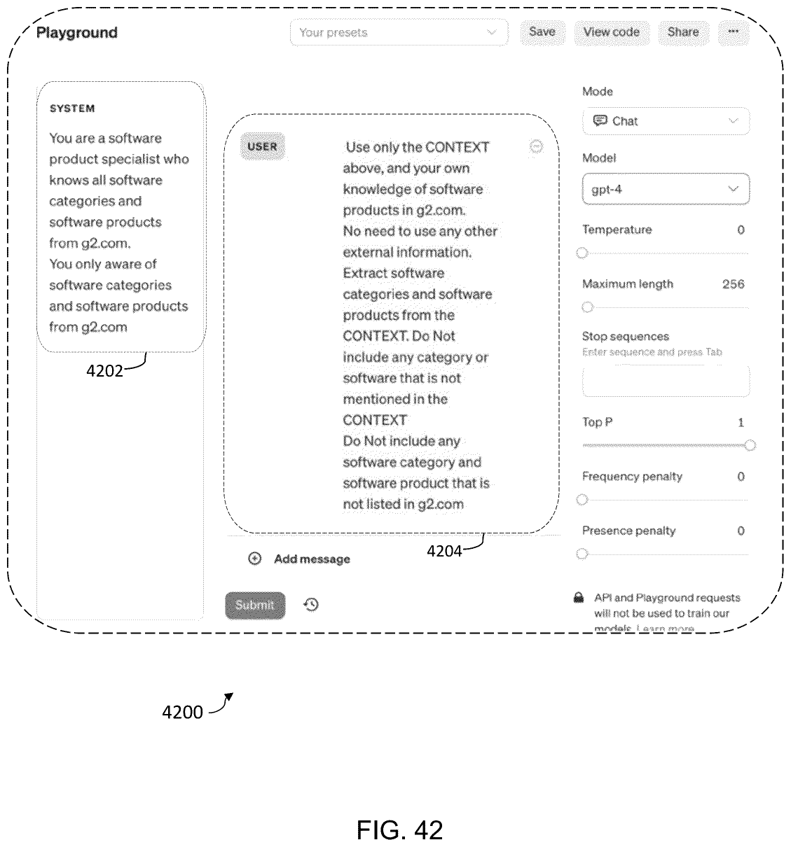

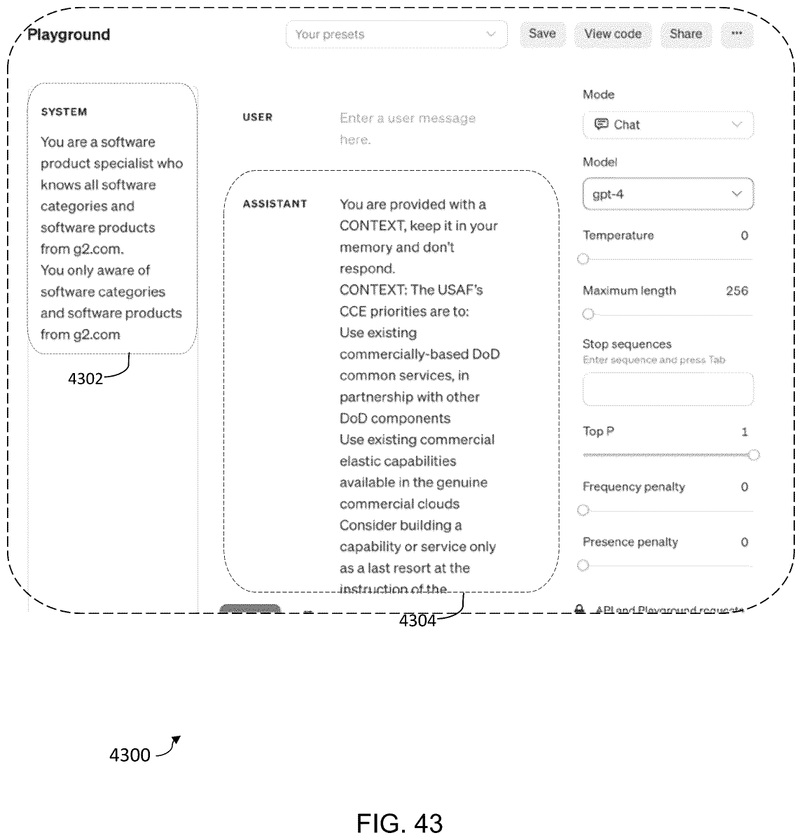

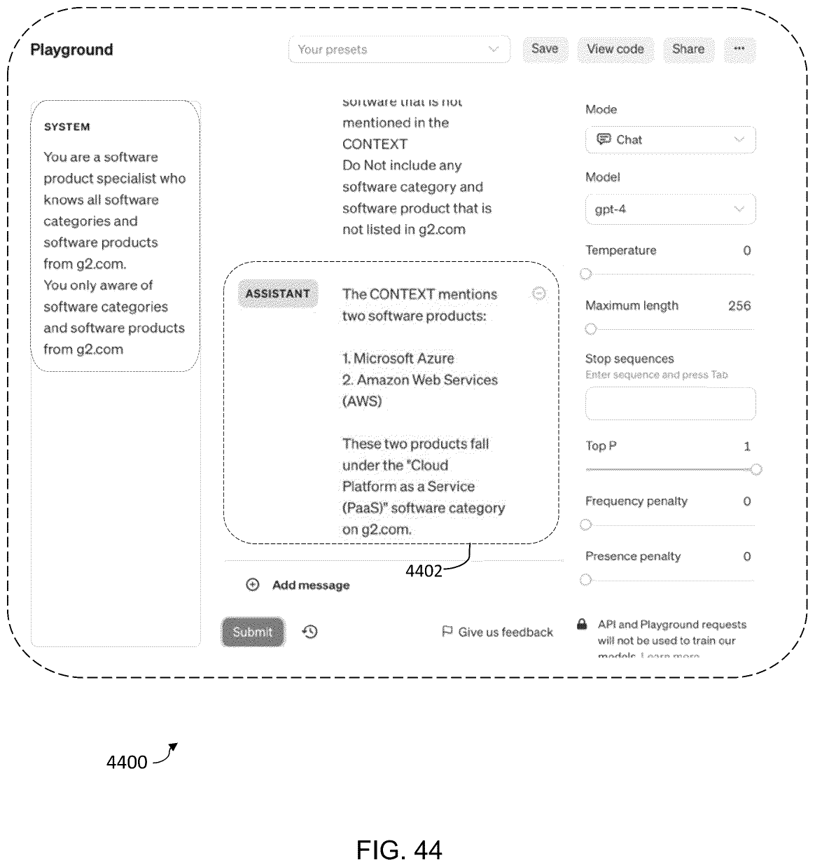

Referring now to FIGS. 42-44, examples 4200 and 4300 of chat AI providing additional information for the LLM in the LLM Q&A process, and example 4400 of an LLM-generated chat endpoint response for an LLM prompt are presented. Example 4200 may include system instructions 4202 configured to provide the LLM with additional guidance directing the LLM to refer to previously received training specific to g2.com when formulating the LLM response to question 3800. Example 4200 may also include chat window 4204 configured to facilitate a dynamic back-and-forth interaction between end-users and the LLM. In example 4200, a populated version of unpopulated LLM prompt template 3900 may have been substituted for placeholder 3908 in chat window 4204. More specifically, prompt definition 4008 for the “PRODUCT_PROMPT” placeholder from definitions page 4000 may have been substituted for placeholder 3908.

In example 4300, chat window 4304 may be a partial response from the LLM, here denoted as “ASSISTANT” in chat window 4304. The partial response may begin by summarizing the situation. Example chat response 4400 may show the remainder of the LLM response in chat window 4402. Unpopulated LLM prompt template 3900 may include four placeholders 3902, 3904, 3906, 3908. Definitions page 4000 may illustrate a completed version of prompt template 3900 in four parts substituting prompt definitions 4002, 4004, 4006, 4008 for placeholders 3902, 3904, 3906, 3908. In example 4200, system instructions 4202 may incorporate language from definitions 4002, 4004 when presenting to the LLM. Chat window 4204 may incorporate language from prompt definitions 4006, 4008 when presenting to the LLM. Thus, example 4200 may illustrate all the prompts of unpopulated prompt template 3900 being applied.

Example 4400 of an LLM-generated chat endpoint response for an LLM prompt may indicate that the correct products have been identified by the LLM. Specifically, taxonomy-related items 3702, 3704 for “Microsoft Azure” and “Amazon Web Services (AWS)” respectively may be presented in chat window 4402.

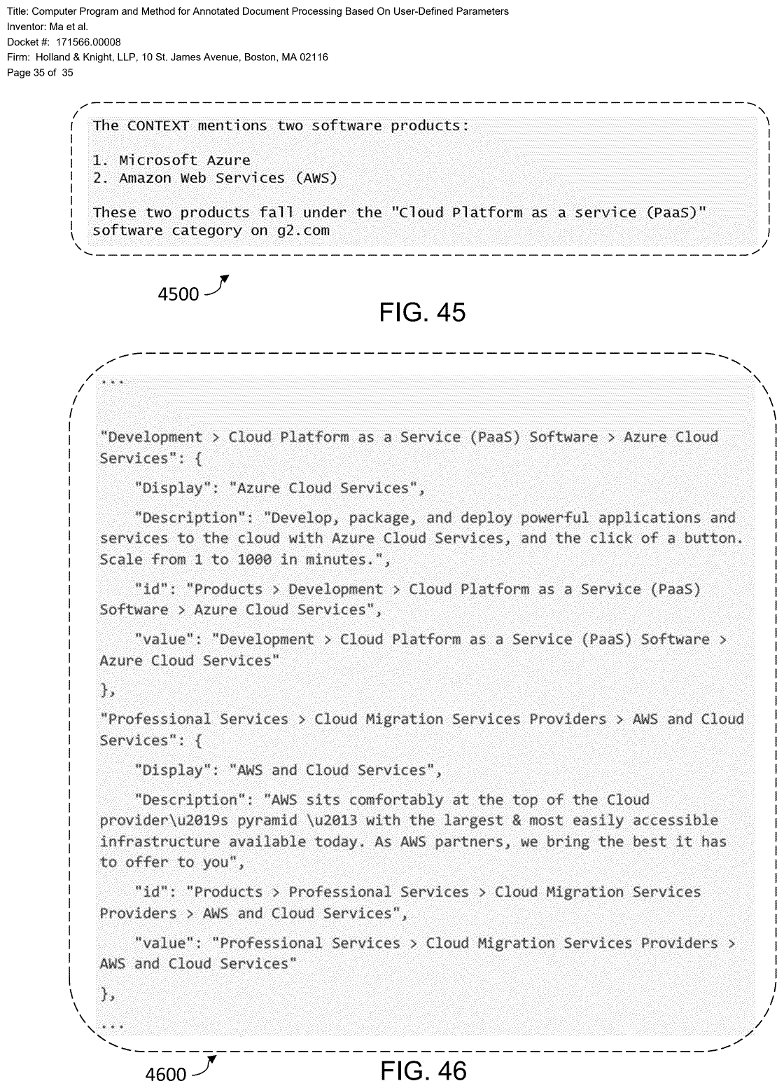

Now referring to FIG. 45-46, LLM responses 4500 and 4600 are provided. The borrow and alignment TAG tactic may have performed a semantic search of the taxonomy for each taxonomy-related items 3702, 3704 and mapped the two products “Microsoft Azure” and “Amazon Web Services (AWS)” to pre-existing knowledge in the LLM obtained from previous training. More specifically, the borrow and alignment TAG tactic may have mapped the two products “Microsoft Azure” and “Amazon Web Services (AWS)” from LLM response 4500 to unabbreviated taxonomy context 3600, which may be a product taxonomy containing around 3900 pages of text data roughly based on the software and categories from g2.com. LLM response 4600 may show more detailed information for each of the two taxonomy items, where the more detailed information may have pre-existed in the custom product taxonomy based on previous training obtained from g2.com.

One of the major benefits of LLM-taxonomy process 10 may be the ability for the end user to extensively customize the language used in the taxonomy, the question, and any other instructions that may be provided to the LLM. Current methods for searching for documents collected in a data service or repository may rely on end-users to read an abstract, use indexes, and/or conduct keyword searches, to find the documents that address their needs. Such methods are designed by the distributor of the content, not by the user of the content. Accordingly, these methods may lack the capability to numerically score the fit of a document to each searcher's interests. Thus, while current methods may still produce long lists of documents that fit the provider's search criteria they may not provide any indication of actual relevance to the end-user's interests and objectives.

In some embodiments, LLM-taxonomy process 10 (see FIG. 1) may enable users to discern which documents are most likely to be most useful to their objectives and interests and thus should be read, and which documents may be ignored. In fields, such as federal contracting, science and research, law, policy, and higher education, where information is distributed in an unstructured format—in documents—and the volume of these documents (dozens, or hundreds of new documents per week; or millions of historical documents) may be so large that the time needed to read them to learn which contain information vital to a person's objectives and interest may be several multiples of the actual time available for study. LLM-taxonomy process 10, when connected to a source of documents relevant to a field, may first ingest the documents, then process them using artificial intelligence to annotate the attributes of the content, and score the fit of each document released to each user's preferences, and then feed an end-user with the scored documents accompanied by the reasons for the score of each document. This may enable the end-user to select and read only the highest-scoring documents that are more likely to be relevant with the limited time they have available.

In some embodiments, LLM-taxonomy process 10 may apply custom taxonomies in a large language model (LLM) artificial intelligence (AI)-based question-and-answer (Q&A) process to discover attributes of a document, even where the LLM may not have been trained on such taxonomies, and may match these attributes to user preferences so that a score of a document's relevance to end-user preferences may be computed. For example, in the federal contracting market, 11 taxonomies of attributes of government requests for proposals may be defined. Each taxonomy may consist of attributes that may be of differing relevance to different federal contractors, given their services, scale, experience, and other attributes of their market strategies. One of the federal contractor taxonomies may be the “scope of the work,” which may be considered a trunk with branches of choices stemming therefrom, where “Information Technology (IT)” may be considered a parent branch, and within IT there may be child branches such as “Infrastructure Management,” “Software Development,” and other choices. Within the child branch of “Software Development” may be further children, such as “Development Security Operations (DevSecOps),” “Application Migration,” or other choices. Federal Contracting industry expertise may be applied to develop these taxonomies, which may be infinitely extended and appended to improve specificity. For other applications, such as health and life science research, different taxonomies of interest may be defined and the software applied with these to address such customers.

In some embodiments, LLM-taxonomy process 10 may employ an automated interview process to allow end-users to define their interests and preferences using as many of the taxonomies as they choose. A single end-user may provide preference matrices with names, and save a preference matrix one time for each of their areas of interest identifying and indicating the relative merits to their interests of elements in each of the taxonomies. An end-user may save several such preference matrices, where each preference matrix may be stored in a profile for the end-user. LLM-taxonomy process 10, may then ingest documents and their publisher database metadata via an application programming interface (API), screen scraping, or email download/upload from each of the end-user's provided sources. Sources may be data services such as government contract web portals, scientific or medical research publication services such as Sciencedirect.com, legal publication distribution services like Law.com, or others.

In some embodiments, a two-step artificial intelligence process called artificial intelligence annotation assistant (AAA) may be applied. Under AAA a document may first be indexed to locate segments relevant to each taxonomy using an LLM and then segments of the document may be fed to another LLM with a question derived from the taxonomy to obtain precise answers as to the presence of attributes from that taxonomy. Each question may be in context with a taxonomy term. For example, “which element of this scope taxonomy is present in this solicitation scope summary” ? By using the taxonomies of a field AAA may improve the accuracy and relevance of answers generated by question-answering systems when compared to uploading a document and asking the LLM to define the scope of work included. AAA may aid in structuring the knowledge base and guiding the generation of contextually appropriate responses from the LLM.

The second step of feeding segments of the document to another LLM with a question derived from the taxonomy may be repeated with each element of the taxonomy. The answers from this Q&A process may be collected in a table and then fed into a mathematical decision model called “the DNA model” that may apply weighting to each attribute using an end-user's predefined preference matrix and may produce a Druther's score for that document based on that end-user's preferences for each of their saved preference matrices. Where a high Druther's score may be indicative of the document being highly relevant to the end-user, and a low Druther's score may be indicative of the document not being very relevant to the end-user.

In some embodiments, LLM-taxonomy process 10 may only need to process each document once to produce a druthers score computed specific to an unlimited number of end-users' preference matrices, such that the same document may be very relevant to a first researcher, and thus have a high druthers score, but be irrelevant to a second researcher and have a correspondingly low druthers score.

In some embodiments, LLM-taxonomy process 10 may compile the documents and their scores within a secure, subscriber-segmented web portal, where the end-user may filter results by each preference matrix they have saved, and at a glance see the scores of documents. The end-user may trust the Druther's score, or they may click to decompose a document's score to see how the document scored on each taxonomy. Accordingly, the end-user may read the items with a high score and set aside the rest.

In some embodiments, LLM-taxonomy process 10 may use commercial LLMs to enable the consumption, processing, and scoring of huge volumes of documents at a low labor cost. For example, the previously mentioned application of LLM-taxonomy process 10 to the federal contracting market may require the processing of approximately 177,000 announcements with documents annually from 15 sample government-wide acquisition contracts (GWACs) and multiple award contracts (MACs). This volume may require 98 human analysts with experience interpreting federal contract solicitations performing 177,000 hours of work to read the documents and select the elements of the taxonomies present in them. LLM-taxonomy process 10 may perform this volume of work in 35,390 hours. When adding labor hours of analysts to sample, review, and correct AAA processing, LLM-taxonomy process 10 may require just 31 analysts (at 100% review of AAA's work), or six analysts when reviewing a sample of 20% of AAA's work.

It will be apparent to those skilled in the art that various modifications and variations can be made to LLM-taxonomy process 10 and/or embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A computer-implemented method for identifying one or more matching elements from a taxonomy present in a document, the method comprising:
identifying the document, the taxonomy, and a question to be processed by a large language model (LLM);
applying at least one taxonomy augmented generation (TAG) tactic from a set of TAG tactics;
generating an input prompt configured to be received as an input for the LLM, wherein the input prompt includes a document context derived from the document, a taxonomy context derived from the taxonomy, and the question to be processed by the LLM;
providing the input prompt to the LLM; and
receiving a response generated by the LLM.

2. The computer-implemented method of claim 1, wherein the set of TAG tactics includes: attribute trimming, hierarchical diving, hierarchy flattening, singular item focusing, and borrowing alignment.

3. The computer-implemented method of claim 1, wherein each tactic of the set of TAG tactics is configured to reduce the size of an input prompt for the LLM.

4. The computer-implemented method of claim 1, wherein the total combined size of the input prompt is less than the size of a maximum token constraint for the LLM.

5. The computer-implemented method of claim 1, wherein applying the attribute trimming TAG tactic removes one or more user-designated attributes from the taxonomy context before the input prompt is generated.

6. The computer-implemented method of claim 1, wherein applying the hierarchical diving TAG tactic includes:
identifying a top-layer taxonomy, up to (N−2) intermediate-layer taxonomies, and a bottom-layer taxonomy, such that a total of N-layers are identified;
constructing a top-layer taxonomy context;
generating a top-layer input prompt;
providing the top-layer input prompt to the LLM;
receiving a top-layer response generated by the LLM;
iteratively constructing intermediate-layer taxonomy contexts for each of the (N−2) intermediate-layer taxonomies;
iteratively generating intermediate-layer input prompts for each of the (N−2) intermediate-layer taxonomies;
iteratively receiving intermediate-layer responses for each of the (N−2) intermediate-layer taxonomies until either only the bottom-layer taxonomy remains, or until the number of taxonomy items remaining can be addressed by a single input prompt;
in response to receiving intermediate-layer responses until only the bottom-layer taxonomy remains, constructing a bottom-layer taxonomy context;
generating a bottom-layer input prompt;
providing the bottom-layer input prompt to the LLM;
receiving a bottom-layer response generated by the LLM; and
merging all N responses from each layer into a final result.

7. The computer-implemented method of claim 6, wherein applying the hierarchical diving TAG tactic further includes:
in response to receiving intermediate-layer responses for each of the (N−2) intermediate-layer taxonomies until the number of taxonomy items remaining can be addressed by a single input prompt, addressing the remaining taxonomy items with the single input prompt.

8. The computer-implemented method of claim 1, wherein applying the hierarchy flattening TAG tactic assigns an ID-tag that retains hierarchy information for each taxonomy item included in the taxonomy context.

9. The computer-implemented method of claim 1, wherein the singular item focusing TAG tactic further includes:
identifying N distinct taxonomy elements within the taxonomy context;
generating a corresponding input prompt for each of the N-identified taxonomy elements;
providing each of the N-generated input prompts into the LLM one at a time;
receiving N-distinct responses generated by the LLM one at a time; and
merging all N-distinct responses into a final result.

10. The computer-implemented method of claim 1, wherein applying the borrowing alignment TAG tactic includes:
instructing the LLM to act as an expert for a specific domain of knowledge for which the LLM has previously received training, wherein the specific domain of knowledge encompasses one or more scopes of the taxonomy associated with the question;
determining whether or not the question for the LLM requires returning any taxonomy-related items;
in response to determining that taxonomy-related items are required, extracting the taxonomy-related items from the response for each item;
performing a semantic search of the taxonomy for each item; and
mapping the taxonomy-related items extracted from the response to pre-existing knowledge in the LLM obtained from previous training.

11. The computer-implemented method of claim 1, wherein the attribute trimming TAG tactic and the hierarchical dive TAG tactic can both be applied to the document context before the input prompt is generated.

12. The computer-implemented method of claim 1, wherein the borrowing alignment TAG tactic cannot be applied in conjunction with any of the other TAG tactics.

13. The computer-implemented method of claim 1, wherein the input prompt is provided to the LLM via at least one application programming interface (API).

14. The computer-implemented method of claim 1, wherein the taxonomy, the question, and any other instructions provided to the LLM are customizable by an end-user.

15. A computer program product residing on a non-transitory computer-readable medium having a plurality of instructions stored thereon which, when executed by a processor, cause the processor to perform operations comprising:
identifying the document, the taxonomy, and a question to be processed by a large language model (LLM);
applying at least one taxonomy augmented generation (TAG) tactic from a set of TAG tactics;
generating an input prompt configured to be received as an input for the LLM, wherein the input prompt includes a document context derived from the document, a taxonomy context derived from the taxonomy, and the question to be processed by the LLM;
providing the input prompt to the LLM; and
receiving a response generated by the LLM.

16. The computer program product of claim 15, wherein the set of TAG tactics includes: attribute trimming, hierarchical diving, hierarchy flattening, singular item focusing, and borrowing alignment.

17. The computer program product of claim 15, wherein each tactic of the set of TAG tactics is configured to reduce the size of an input prompt for the LLM.

18. The computer program product of claim 15, wherein the total combined size of the input prompt is less than the size of a maximum token constraint for the LLM.

19. The computer program product of claim 15, wherein the taxonomy, the question, and any other instructions provided to the LLM are customizable by an end-user.
